(19) United States
(12) Patent Application Publication
(10) Pub. No.: US 2016/0225396 A1
(43) Pub. Date: Aug. 4, 2016

(54) GLASS FOR MAGNETIC RECORDING MEDIUM SUBSTRATE AND MAGNETIC RECORDING MEDIUM SUBSTRATE

(71) Applicant: HOYA CORPORATION, Tokyo (JP)

(72) Inventor: Shoji SHIMOJIMA, Tachikawa-shi (JP)

(73) Assignee: HOYA CORPORATION, Tokyo (JP)

(21) Appl. No.: 15/021,204

(22) PCT Filed: Sep. 10, 2014
(86) PCT No.: PCT/JP2014/073911

§ 371 Date: Mar. 10, 2016

(30) Foreign Application Priority Data
Sep. 11, 2013 (JP) 2013-188315

(51) Int. Cl. G11B 5/73; C03C 3/085; C03C 21/00

(52) U.S. Cl. CPC G11B 5/7315; C03C 21/002; C03C 3/085

(57) ABSTRACT

A glass for a magnetic recording medium substrate, which contains SiO₂, Li₂O, Na₂O, and MgO as essential components; alkali metal oxides selected from the group consisting of Li₂O, Na₂O, and K₂O of 6 to 15 mol % in total; alkaline earth metal oxides selected from the group consisting of MgO, CaO, SrO, and BaO of 10 to 30 mol % in total. A molar ratio of a content of Li₂O to a total content of alkali metal oxides {Li₂O/(Li₂O+Na₂O+K₂O)} is greater than 0 and less than or equal to 0.3; a molar ratio of a content of MgO to a total content of alkaline earth metal oxides {MgO/(MgO+CaO+SrO+BaO)} is greater than or equal to 0.80; a glass transition temperature is greater than or equal to 650° C.; and a Young's modulus is greater than or equal to 80 GPa.

### CROSS-REFERENCE TO RELATED APPLICATIONS

This application claims the benefit of priority to Japanese Patent Application No. 2013-188315 filed on Sep. 11, 2013, which is expressly incorporated herein by reference in its entirety.

### TECHNICAL FIELD

The present invention relates to glass for a magnetic recording medium substrate that is suitable as a substrate material of magnetic recording media such as hard disks, and a magnetic recording medium substrate employing the above glass.

### BACKGROUND ART

With the development of information-related infrastructure such as the Internet, the need for information recording media such as magnetic disks and optical disks has increased sharply. The main structural components of the magnetic memory (recording) devices of computers and the like are magnetic recording media and magnetic heads for magnetic recording and reproduction. Known magnetic recording media include flexible disks and hard disks. Of these, examples of the substrate materials employed in hard disks (magnetic disks) include aluminum substrates, glass substrates, ceramic substrates, and carbon substrates. In practical terms, depending on size and application, aluminum substrates and glass substrates are primarily employed. In the hard disk drives of laptop computers, along with higher density recording of magnetic recording media in addition to impact resistance, the requirement of increased surface smoothness of the disk substrate is intensifying. Thus, there are limits to how well aluminum substrates, with afford poor surface hardness and rigidity, can respond. Accordingly, the development of glass substrates is currently the mainstream (see, for example, Japanese Unexamined Patent Publication (KOKAI) No. 2001-134925, Japanese Unexamined Patent Publication (KOKAI) No. 2011-251854, Japanese Unexamined Patent Publication (KOKAI) No. 2004-43295 or English language family members US2003/220183A1, U.S. Pat. No. 7,309,671, US2008/053152A1, and U.S. Pat. No. 7,767,607, Japanese Unexamined Patent Publication (KOKAI) No. 2005-314159 or English language family members US 2005/244656A1 and U.S. Pat. No. 7,595,273, which are expressly incorporated herein by reference in their entirety).

In recent years, with the goal of achieving even higher density recording in magnetic recording media, the use of magnetic materials of high magneto-anisotropic energy (magnetic materials of high Ku (crystal magnetic anisotropy constant) value), such as Fe—Pt and Co—Pt based materials, is being examined (see, for example, Japanese Unexamined Patent Publication (KOKAI) No. 2004-362746 or English language family members US 2004/229006A1 and U.S. Pat. No. 7,189,438, which are expressly incorporated herein by reference in their entirety). It is necessary to reduce the particle diameter of the magnetic particles to achieve higher density recording. However, when just the particle diameter is reduced, the deterioration of magnetic characteristics due to thermal fluctuation becomes a problem. Magnetic materials of high Ku value tend not to be affected by thermal fluctuation, and are thus expected to contribute to the achievement of greater recording density.

### SUMMARY OF THE INVENTION

However, magnetic materials of high Ku value must be in a specific state of crystal orientation to exhibit a high Ku value. Thus, a film must be formed at high temperature or heat treatment must be conducted at high temperature following film formation. Accordingly, the formation of a magnetic recording layer comprised of such magnetic materials of high Ku value requires that a glass substrate have high heat resistance that is capable of withstanding the processing at high temperatures, that is, have a high glass transition temperature.

Additionally, glass substrates constituting magnetic recording media are also required to afford a high degree of mechanical strength. Since a magnetic recording medium will rotate, for example, at a high speed of several thousand to several tens of thousands of rotations per minute, glass substrates are required to have a high degree of rigidity (a high Young's modulus) so that they do not undergo substantial deformation during high-speed rotation. Glass substrates are also required to have good impact resistance so that they are not damaged by cracking, splitting, or the like during collisions with the magnetic head and magnetic recording medium or the magnetic memory device itself. In particular, glass substrates for magnetic recording media that are employed at extremely high recording densities, such as magnetic recording media of the heat-assisted type that have been under investigation in recent years, are required to have a high degree of mechanical strength.

However, when the composition of the glass is adjusted to increase the heat resistance of a glass substrate that is to be used to increase the recording density of a magnetic recording medium, mechanical strength tends to decrease.

An aspect of the present invention provides for glass for a magnetic recording medium substrate, and a magnetic recording medium substrate, that afford both high heat resistance and a high degree of mechanical strength.

An aspect of the present invention relates to glass for a magnetic recording medium substrate, which contains:

SiO₂, Li₂O, Na₂O, and MgO as essential components;

alkali metal oxides selected from the group consisting of Li₂O, Na₂O, and K₂O of 6 to 15 mol % in total;

alkaline earth metal oxides selected from the group consisting of MgO, CaO, SrO, and BaO of 10 to 30 mol % in total;

wherein a molar ratio of a content of Li₂O to a total content of the alkali metal oxides {Li₂O/(Li₂O+Na₂O+K₂O)} is greater than 0 and less than or equal to 0.3;

a molar ratio of a content of MgO to a total content of the alkaline earth metal oxides {MgO/(MgO+CaO+SrO+BaO)} is greater than or equal to 0.80;

a glass transition temperature is greater than or equal to 650° C.; and

a Young's modulus is greater than or equal to 80 GPa.

The above glass for a magnetic recording medium substrate is glass that is formed of a glass composition having high degrees of heat resistance and mechanical strength, affording both a high glass transition temperature and a high Young's modulus.

The present invention can provide a magnetic recording medium substrate having a high degree of heat resistance allowing it to withstand high-temperature heat treatment to form a magnetic recording layer comprised of a magnetic material with a high Ku, and having a high degree of mechanical strength allowing it to withstand high-speed rotation and impact; and can provide a magnetic recording medium including this substrate.

### BRIEF DESCRIPTION OF THE DRAWINGS

FIG. 1 is a schematic drawing of the stress profile in a chemically strengthened glass substrate.

FIG. 2 is a schematic drawing of the stress profile in a chemically strengthened glass substrate.

FIG. 3 is a descriptive drawing of expression (1).

FIG. 4 is a descriptive drawing of expression (1).

FIG. 5 is a graph showing the relation of the molar ratio {MaO/(MgO+CaO+SrO+BaO)} and the fracture toughness value of a chemically strengthened glass substrate.

FIG. 6 is a graph showing the relation of the molar ratio {CaO/(MgO+CaO+SrO+BaO)} and the fracture toughness value of a chemically strengthened glass substrate.

### MODE FOR CARRYING OUT THE INVENTION

The glass for a magnetic recording medium substrate according to an aspect of the present invention is glass for a magnetic recording medium substrate, which contains SiO₂, Li₂O, Na₂O, and MgO as essential components, alkali metal oxides selected from the group consisting of Li₂O, Na₂O, and K₂O of 6 to 15 mol % in total, alkaline earth metal oxides selected from the group consisting of MgO, CaO, SrO, and BaO of 10 to 30 mol % in total, wherein a molar ratio of a content of Li₂O to a total content of the alkali metal oxides {Li₂O/(Li₂O+Na₂O+K₂O)} is greater than 0 and less than or equal to 0.3, a molar ratio of a content of MgO to a total content of the alkaline earth metal oxides {MgO/(MgO+CaO+SrO+BaO)} is greater than or equal to 0.80, a glass transition temperature is greater than or equal to 650° C., and a Young's modulus is greater than or equal to 80 GPa.

A further aspect of the present invention relates to:

a magnetic recording medium substrate, which is comprised of the glass for a magnetic recording medium substrate according to an aspect of the present invention; and

a magnetic recording medium substrate, which is a substrate that has been obtained by chemically strengthening the glass for a magnetic recording medium substrate according to an aspect of the present invention.

The various characteristics of the glass for a magnetic recording medium substrate and the substrate according to an aspect of the present invention will be described below. Unless specifically stated otherwise, the various characteristics described below refer to values after chemical strengthening in the case of chemically strengthened substrates.

1. Glass Transition Temperature

As set forth above, when attempting to achieve a high recording density in a magnetic recording medium by introducing a high Ku magnetic material or the like, the glass substrate for a magnetic recording medium is exposed to high temperature during high-temperature treatment of the magnetic material and the like. In this process, to prevent loss of the extremely high degree of flatness of the substrate, excellent heat resistance is demanded of the glass substrate for a magnetic recording medium. Employing the glass transition temperature as an index of heat resistance, having the glass according to an aspect of the present invention possess a glass transition temperature of greater than or equal to 650° C. makes it possible to maintain good flatness following high-temperature processing. Accordingly, the glass according to an aspect of the present invention is suitable for the fabrication of a substrate for a magnetic recording medium comprising a high Ku magnetic material. The desirable range of the glass transition temperature is greater than or equal to 670° C. The upper limit of the glass transition temperature can be about 750° C., for example. However, the higher the glass transition temperature the better and there is no specific limit. The glass transition temperature is a value that remains nearly constant before and after chemical strengthening.

2. Young's Modulus

Deformation of a magnetic recording medium includes deformation due to high speed rotation in addition to deformation due to change in the temperature of an HDD.

It is required to raise the Young's modulus of the magnetic recording medium substrate as set forth above to inhibit deformation during high-speed rotation. The glass according to an aspect of the present invention has a Young's modulus of greater than or equal to 80 GPa. Thus, substrate distortion can be inhibited during high-speed rotation. Even in a high density recording magnetic recording medium in which a high Ku magnetic material has been incorporated, data reading and writing can be correctly conducted.

The range of the Young's modulus is desirably greater than or equal to 81 GPa, preferably greater than or equal to 82 GPa, more preferably greater than or equal to 83 GPa, still more preferably greater than or equal to 84 GPa, yet more preferably greater than or equal to 85 GPa, and yet still more preferably, greater than or equal to 86 GPa. The upper limit of the Young's modulus is not specifically limited. To keep other characteristics within desirable ranges, an upper limit of 95 GPa, for example, can be considered as a yardstick. The Young's modulus is also a value that remains nearly unchanged before and after chemical strengthening treatment.

3. Thermal Expansion Coefficient

As set forth above, when there is a large difference in coefficient of thermal expansion between the glass constituting the glass substrate for a magnetic recording medium and the spindle material (such as stainless steel) of an HDD, changes in temperature during the operation of the HDD cause the magnetic recording medium to deform, problems occur in recording and reproduction, and reliability ends up being compromised. In particular, in magnetic recording media having a magnetic recording layer comprised of a magnetic material of high Ku, the recording density is extremely high. Thus, even slight deformation of the magnetic recording medium tends to cause these problems.

Generally, HDD spindle materials have an average coefficient of linear expansion (thermal expansion coefficient) of greater than or equal to 55×10⁻⁷/° C. over the range of 100 to 300° C. Since the glass according to an aspect of the present invention has an average coefficient of linear expansion of greater than or equal to 55×10⁻⁷/° C. over the range of 100 to 300° C., it is possible to enhance the reliability and to provide a substrate that is suited to a magnetic recording medium having a magnetic recording layer comprised of a high Ku magnetic material.

The average coefficient of linear expansion desirably falls within a range of greater than or equal to 60×10⁻⁷/° C., preferably within a range of greater than or equal to 63×10⁻⁷/° C., more preferably within a range of greater than or equal to 65×10⁻⁷/° C., still more preferably within a range of greater than or equal to 70×10⁻⁷/° C., and yet more preferably, within a range of greater than or equal to 75×10⁻⁷/° C. When the thermal expansion characteristics of the spindle material are taken into account, the upper limit of the average coefficient of linear expansion is, for example, desirably about 120×10⁻⁷/° C., preferably 100×10⁻⁷/° C., and more preferably, 88×10⁻⁷/° C. The thermal expansion coefficient is a value that remains nearly constant before and after chemical strengthening.

Further, in an embodiment, the average coefficient of linear expansion over the temperature range of 500 to 600° C. is desirably greater than or equal to 60×10⁻⁷/° C., preferably greater than or equal to 70×10⁻⁷/° C. The upper limit of the average coefficient of linear expansion is, for example, desirably less than or equal to 100×10⁻⁷/° C., preferably 90×10⁻⁷/° C. By fabricating a substrate using glass having an average coefficient of linear expansion over the temperature range of 500 to 600° C. falling within the above-stated range, it is possible to reliably prevent separation of multiple layers of films from the glass substrate during and after annealing treatment following the formation of multiple layers of films of a high Ku magnetic material and the like, and detachment of the substrate from the support member during the annealing treatment.

4. Specific Modulus of Elasticity and Specific Gravity

To inhibit deformation (substrate bending) of the magnetic recording medium during high-speed rotation, glass having a high specific modulus of elasticity is desirable as the substrate material. The specific modulus of elasticity is also a value that remains nearly constant before and after chemical strengthening. The range of the specific modulus of elasticity in the glass according to an aspect of the present invention is desirably greater than or equal to 30.0 MNm/kg, preferably greater than 30.0 MNm/kg, and more preferably, greater than or equal to 30.5 MNm/kg. The upper limit is about 40.0 MNm/kg, for example, but is not specifically limited. The specific modulus of elasticity is obtained by dividing the Young's modulus of the glass by the density. In this context, the “density” can be thought of as a quantity in units of g/cm³ applied to the specific gravity of the glass. The specific modulus of elasticity can be increased by lowering the specific gravity of the glass, as well as by reducing the weight of the substrate. The weight of the magnetic recording medium is reduced by reducing the weight of the substrate, thereby reducing the power that is required to rotate the magnetic recording medium and keeping down the power consumption of the HDD. The range of the specific gravity of the glass according to an aspect of the present invention is desirably less than or equal to 2.90, preferably less than or equal to 2.80, and more preferably, less than 2.70.

5. Fracture Toughness Value

The fracture toughness value is measured by the following method.

An MVK-E apparatus made by Akashi Corp. is employed. A sample that has been processed into sheet form is pressed with a Vickers indenter at a load P [N] to introduce an indentation and cracks into the sample. Denoting the Young's modulus as E [GPa], the diagonal length of indentation as d [m], and the surface crack half-length as a [m], the fracture toughness value K_{1c} [Pa·m^{1/2}] is given by the following equation:

K_{1c}=[0.026(EP/π)^{1/2}(d/2)(a)⁻²]/[(πa)^{-1/2}]

The fracture toughness value (load P=9.81 N (1,000 gf)) of the glass constituting the substrate according to an aspect of the present invention is desirably greater than or equal to 0.9 MPa·m^{1/2}. There is a trade-off between the fracture toughness value and heat resistance. When the heat resistance of the substrate is raised to increase the recording density of the magnetic recording medium, the fracture toughness value decreases and impact resistance ends up diminishing. By contrast, an aspect of the present invention can provide a glass substrate that is suited to a magnetic recording medium corresponding to a high recording density and achieving a balance between heat resistance, rigidity, and thermal expansion characteristics while raising the fracture toughness value. The fracture toughness value desirably falls within a range of greater than or equal to 1.0 MPa·m^{1/2}, preferably falls within a range of greater than or equal to 1.1 MPa·m^{1/2}, and more preferably, falls within a range of greater than or equal to 1.2 MPa·m^{1/2}. By having a fracture toughness value of greater than or equal to 0.9 MPa·m^{1/2}, it becomes possible to provide a magnetic recording medium of good impact resistance, high reliability, and corresponding to a high recording density. Unless specifically stated otherwise, in the present invention, the fracture toughness value means the fracture toughness value as measured at a load P of 9.81 N (1,000 gf). The fracture toughness value is desirably measured on a smooth glass surface, such as a polished surface, from the perspective of accurate measurement of the diagonal length of indentation d and the surface crack half-length a. In the present invention, the fracture toughness value of a substrate of chemically strengthened glass is the value of the glass that has been chemically strengthened. Since the fracture toughness value varies with the composition of the glass and the chemical strengthening conditions, the magnetic recording medium substrate according to an aspect of the present invention comprised of chemically strengthened glass can be obtained by adjusting the composition and chemical strengthening treatment conditions to keep the fracture toughness value within the desired range.

The fracture toughness value of the glass constituting the substrate according to an aspect of the present invention can also be denoted as the fracture toughness value at a load P of 4.9 N (500 gf). In that case, the fracture toughness value (load P=4.9 N (500 gf)) desirably exceeds 0.9 MPa·m^{1/2}, is preferably greater than or equal to 1.0 MPa·m^{1/2}, is more preferably greater than or equal to 1.1 MPa·m^{1/2}, is still more preferably greater than or equal to 1.2 MPa·m^{1/2}, and is yet still more preferably greater than or equal to 1.3 MPa·m^{1/2}.

6. Acid Resistance

In the course of producing a glass substrate for a magnetic recording medium, the glass is processed into a disk shape, and the main surfaces are processed to be extremely flat and smooth. Following these processing steps, the glass substrate is usually washed with acid to remove organic material in the form of grime that has adhered to the surface. If the glass substrate has poor resistance to acid, surface roughening occurs during the cleaning with acid, flatness and smoothness are lost, and use as a glass substrate for a magnetic recording medium becomes difficult. It is particularly desirable for a glass substrate for use in a high recording density magnetic recording medium having a magnetic recording layer comprised of a high Ku magnetic material in which high flatness and smoothness of the glass substrate surface are required to have good acid resistance.

It is also possible to obtain a substrate in an even cleaner state by removing foreign material such as abrasive that has adhered to the surface by washing with an alkali following washing with an acid. To prevent a decrease in the flatness and smoothness of the substrate surface due to surface roughening during alkali washing, it is desirable for the glass substrate to have good resistance to alkalinity. Having good resistance to acidity and alkalinity with a high degree of flatness and smoothness of the substrate surface are advantageous from the perspective of achieving the above-described low flying height. In an embodiment of the present invention, by adjusting the glass composition, particularly by adjustment to a composition that is advantageous to chemical durability, makes it possible to achieve good resistance to acidity and alkalinity.

7. Liquidus Temperature

The liquidus temperature refers to the lowest maintenance temperature at which crystals do not precipitate when the temperature of solid glass is raised over a prescribed range of speeds and maintained at various temperatures. In the course of melting glass and molding the glass melt obtained, the glass crystallizes and a homogenous glass cannot be produced when the molding temperature is lower than the liquidus temperature. Thus, the glass molding temperature must be greater than or equal to the liquidus temperature. However, when the molding temperature exceeds 1,300° C., for example, the pressing mold employed in the course of press molding a glass melt reacts with the hot glass and tends to be damaged. Even when conducting molding by casting a glass melt into a casting mold, the casting mold tends to be similarly damaged. Taking these points into account, the liquidus temperature of the glass according to an aspect of the present invention is desirably less than or equal to 1,300° C. The liquidus temperature preferably falls within a range of less than or equal to 1,280° C., more preferably a range of less than or equal to 1,250° C. In an embodiment the present invention, the liquidus temperature within the above desirable range can be achieved by conducting the adjustment of glass composition. The lower limit is not specifically limited, but a temperature of greater than or equal to 800° C. can be thought of as a yardstick.

8. Spectral Transmittance

A magnetic recording medium is produced by a process of forming a multilayered film comprising a magnetic recording layer on a glass substrate. In the course of forming a multilayered film on a substrate by the single substrate film forming method that is currently the mainstream, for example, the glass substrate is first introduced into the substrate heating region of a film-forming apparatus and heated to a temperature at which film formation by sputtering or the like is possible. Once the temperature of the glass substrate has risen adequately, the glass substrate is moved to a first film-forming region where a film corresponding to the lowest layer of the multilayer film is formed on the glass substrate. Next, the glass substrate is moved to a second film-forming region where a film is formed over the lowermost layer. The multilayered film is thus formed by sequentially moving the glass substrate to subsequent film-forming regions and forming films. Since the heating and film formation are conducted under reduced pressure achieved by evacuation with a vacuum pump, heating of the substrate must be conducted by a non-contact method. Thus, the glass substrate is suitably heated by radiation. This film formation must be conducted while the glass substrate is not at a temperature that is lower than the temperature suited to film formation. When the time required for forming each layer of the film is excessively long, the temperature of the glass substrate that has been heated drops, and there is a problem in that it is impossible to achieve an adequate glass substrate temperature in subsequent film-forming regions. To maintain the glass substrate at a temperature permitting film formation for an extended period, heating the substrate to a higher temperature is conceivable. However, when the heating rate of the glass substrate is low, the heating period must be extended, and the time during which the glass substrate remains in the heating region must be increased. Thus, the residence time of the glass substrate in each film-forming region increases, and an adequate glass substrate temperature ends up not being maintained in subsequent film-forming regions. Further, it becomes difficult to increase throughput. In particular, when producing a magnetic recording medium comprising a magnetic recording layer comprised of a magnetic material of high Ku, it is desirable to further increase the efficiency of heating the glass substrate with radiation so as to heat the glass substrate to a high temperature within a prescribed period.

In glasses containing SiO₂ and Al₂O₃, absorption peaks are present in the region containing the wavelengths of 2,750 to 3,700 nm. The absorption of radiation at shorter wavelengths can be increased by adding an infrared-absorbing agent, described further below, or by incorporating it as a glass component, thereby imparting absorption in the wavelength range of wavelengths of 700 to 3,700 nm. The use of infrared radiation having a spectral maximum in the above wavelength range is desirable to efficiently heat the glass substrate with radiation, that is, by irradiation with infrared radiation. It is conceivable to increase the power of the infrared radiation while matching the maximum spectral wavelength of the infrared radiation with the peak absorption wavelength of the substrate. Taking the example of a high-temperature carbon heater as an infrared source, it suffices to increase the input to the carbon heater to increase the power of the infrared radiation. However, considering the radiation from the carbon heater as black body radiation, an increase in the input increases the heater temperature. This shifts the maximum wavelength of the infrared radiation spectrum to the short wavelength side, ending up outside the absorption wavelength region of the glass. Thus, the powder consumption of the heater must be made excessively high to increase the heating rate of the substrate, creating a problem by shortening the service lifetime of the heater or the like.

In light of such points, increasing the absorption of the glass in the above wavelength region (wavelengths 700 to 3,700 nm), irradiating infrared radiation with the maximum spectral wavelength of the infrared radiation in a state of proximity to the peak absorption wavelength of the substrate, and not employing an excessive heater input are desirable. Accordingly, to increase the infrared radiation heating efficiency, either the presence of a region in which the spectral transmittance as converted to a thickness of 2 mm is less than or equal to 50 percent in the 700 to 3,700 nm wavelength region in the glass substrate, or a glass substrate with transmittance characteristics such that the spectral transmission as converted to a thickness of 2 mm is less than or equal to 70 percent over the above wavelength region is desirable. For example, the oxide of at least one metal selected from the group consisting of iron, copper, cobalt, ytterbium, manganese, neodymium, praseodymium, niobium, cerium, vanadium, chromium, nickel, molybdenum, holmium, and erbium can function as an infrared-absorbing agent. Further, water or OH groups contained in water absorb strongly in the 3 μm band, so water can also function as an infrared-absorbing agent. Incorporating a suitable quantity of a component that is capable of functioning as the above infrared-absorbing agent into the glass composition can impart the above desirable absorption characteristic to the glass substrate. The quantity added of the oxide that is capable of functioning as the infrared-absorbing agent is desirably 500 ppm to 5 percent, preferably 2,000 ppm to 5 percent, more preferably 2000 ppm to 2 percent, and still more preferably, falls within a range of 4,000 ppm to 2 percent based on the mass as the oxide. For water, the incorporation of more than 200 ppm is desirable, and the incorporation of more than or equal to 220 ppm is preferred, based on weight as converted to H₂O.

When employing Yb₂O₃ and Nb₂O₅ as glass components, and when adding Ce oxide as a clarifying agent, infrared absorption by these components can be used to enhance substrate heating efficiency.

The glass for a magnetic recording medium substrate according to an aspect of the present invention is an oxide glass. The glass composition is indicated based on oxides. The term “glass composition based on oxides” refers to a glass composition that is obtained by conversion when all of the glass starting materials fully break down during melting and are present in the glass as oxides. The above glass is desirably an amorphous glass because the amorphous glass does not require a heat treatment step for crystallization and affords good processing qualities.

The glass for a magnetic recording medium substrate according to an aspect of the present invention is suited to chemical strengthening. In an embodiment of the present invention, chemical strengthening means low-temperature chemical strengthening.

In the present invention, “main surfaces” means the surfaces with the broadest areas among the surfaces of the glass substrate or glass. In the case of a disk-shaped glass substrate, the pair of surfaces on the opposing front and back of the round disk shape (excluding the center hole when one is present) corresponds to the main surfaces.

The glass composition of the glass for a magnetic recording medium substrate contains SiO₂, Li₂O, Na₂O, and MgO as essential components, alkali metal oxides selected from the group consisting of Li₂O, Na₂O, and K₂O of 6 to 15 mol % in total, alkaline earth metal oxides selected from the group consisting of MgO, CaO, SrO, and BaO of 10 to 30 mol % in total, wherein a molar ratio of a content of Li₂O to a total content of the alkali metal oxides {Li₂O/(Li₂O+Na₂O+K₂O)} is greater than 0 and less than or equal to 0.3, and a molar ratio of a content of MgO to a total content of the alkaline earth metal oxides {MgO/(MgO+CaO+SrO+BaO)} is greater than or equal to 0.80

The glass composition of the glass for a magnetic recording medium substrate according to an aspect of the present invention will be described in greater detail below. Unless specifically stated otherwise, the contents, total contents, and ratios of the various components are denoted in molar basis.

SiO₂ is a glass network forming component that has the effects of enhancing glass stability, chemical durability, and in particular, acid resistance. It is a component that serves to lower the thermal dispersion of the substrate and raise heating efficiency when heating the substrate with radiation in the process of forming a magnetic recording layer and the like on the glass substrate for a magnetic recording medium and to heat films that have been formed by the above process.

When the content of SiO₂ is excessive, the SiO₂ does not fully melt, unmelted material is produced in the glass, the viscosity of the glass becomes excessive during clarification, and inadequate defoaming occurs. When fabricating a substrate from glass containing unmelted material, protrusions are produced by polishing due to the unmelted material on the surface of the substrate, precluding use as the substrate of a magnetic recording medium of which an extremely high degree of surface smoothness is required. When fabricating a substrate from glass containing bubbles, some of the bubbles are exposed on the surface of the substrate by polishing. These become pits, compromising the smoothness of the main surface of the substrate and finally precluding its use as the substrate of a magnetic recording medium. For these reasons, the SiO₂ content is desirably kept to 56 to 75%, preferably to 58 to 70%, and more preferably, to 60 to 67%.

Al₂O₃ is a component that contributes to forming the network of the glass and that serves to enhance rigidity and heat resistance. From the perspective of maintaining good resistance to devitrification (stability) in the glass, the Al₂O₃ content is desirably less than or equal to 20%. From the perspectives of maintaining good glass stability, chemical durability, and heat resistance, the Al₂O₃ content is desirably greater than or equal to 1%. From the perspectives of glass stability, chemical durability, and heat resistance, the content of Al₂O₃ preferably falls within a range of 1 to 15%, and more preferably, within a range of 1 to 11%. From the perspectives of glass stability, chemical durability, and heat resistance, the Al₂O₃ content preferably falls within a range of 1 to 10%, preferably within a range of 2 to 9%, and more preferably, within a range of 3 to 8%. From the perspective of conducting chemical strengthening of the glass substrate, the Al₂O₃ content desirably falls within a range of 5 to 20%.

The preferred glasses among the above glasses containing SiO₂ and Al₂O₃ are those containing a glass component in the form of an alkali metal oxide R₂O (where R denotes Li, Na, or K). R₂O has the effects of improving the melting property of the glass and enhancing the homogeneity of the glass. It also has the effect of raising the coefficient of thermal expansion, and is a component that makes chemical strengthening possible. In the glass for a magnetic recording medium substrate according to an aspect of the present invention, Li₂O and Na₂O, which serve to effectively chemically strengthen the glass without loss of a high degree of heat resistance, are incorporated as R₂O in the form of essential components.

When the quantity of Li₂O incorporated is excessive relative to the total content of alkali metal oxides (Li₂O+Na₂O+K₂O), it causes a drop in heat resistance. When excessively low, it causes a drop in chemical strengthening performance. Accordingly, in the glass for a magnetic recording medium substrate according to an aspect of the present invention, the quantity of Li₂O that is incorporated is adjusted relative to the total content of alkali metal oxides so that the molar ratio of the Li₂O content to the total content of alkali metal oxides {Li₂O/(Li₂O+Na₂O+K₂O)} is greater than 0 and less than or equal to 0.3. From the perspective of inhibiting a drop in heat resistance while achieving the effects of incorporating Li₂O, the upper limit of the molar ratio of {Li₂O/(Li₂O+Na₂O+K₂O)} is preferably 0.25, more preferably 0.20, and still more preferably, 0.15. From the perspective of inhibiting a drop in chemical strengthening performance, the lower limit of the molar ratio of {Li₂O/(Li₂O+Na₂O+K₂O)} is desirably 0.001, preferably 0.005, and more preferably, 0.01. The alkali metal oxides selected from the group consisting of Li₂O, Na₂O, and K₂O will on occasion be collectively denoted as R₂O below.

Li₂O is a component that raises the rigidity of the glass. In addition, based on the ease of displacement within glass of alkali metals, the order is Li>Na>K. Thus, from the perspective of chemical strengthening performance, the incorporation of Li is advantageous.

Accordingly, in the glass for a magnetic recording medium according to an aspect of the present invention, Li₂O is contained as an essential component. From the perspective of inhibiting a drop in heat resistance (a drop in the glass transition temperature), the quantity of Li₂O incorporated is desirably kept to less than or equal to 4%. That is, the quantity of Li₂O incorporated is desirably greater than 0% and less than or equal to 4%, preferably greater than 0% and less than or equal to 3%. From the perspectives of a high degree of rigidity, a high degree of heat resistance, and chemical strengthening performance, the content of Li₂O incorporated more preferably falls within a range of 0.05 to 3%, still more preferably falls within a range of 0.05 to 2%, yet more preferably falls within a range of 0.07 to 1%, and yet still more preferably falls within a range of 0.08 to 0.5%.

Na₂O is a component that has the effect of enhancing thermal expansion characteristics. It is thus desirably incorporated in a quantity of greater than or equal to 1%. Since Na₂O is a component that contributes to chemical strengthening performance, the incorporation of a quantity of greater than or equal to 1% is advantageous also from the perspective of chemical strengthening performance. From the perspective of maintaining good heat resistance, the Na₂O content is desirably less than 15%. Accordingly, the Na₂O content is desirably greater than or equal to 1% and less than 15%. From the perspectives of the thermal expansion characteristic, heat resistance, and chemical strengthening performance, the Na₂O content preferably falls within a range of 4 to 13%, and more preferably, within a range of 5 to 11%.

K₂O is an effective component for improving the thermal expansion characteristic. However, the incorporation of an excessive quantity causes drops in heat resistance and thermal conductivity, as well as results in deterioration of chemical strengthening performance. K has a higher atomic number than the other alkali metals Li and Na, and serves to lower the fracture toughness value among the alkali metal components. In the case where the substrate according to an aspect of the present invention is employed as a chemically strengthened glass substrate, K serves to lower the efficiency of ion exchange. Accordingly, the glass for a magnetic recording medium substrate according to an aspect of the present invention is desirably glass with a K₂O content of less than 3%. The content of K₂O preferably falls within a range of 0 to 2%, more preferably falls within a range of 0 to 1%, still more preferably falls within a range of 0 to 0.5%, yet more preferably falls within a range of 0 to 0.1%, and even more preferably, is essentially not incorporated. In the present invention, the terms “essentially not contained” and “essentially not incorporated” mean not intentionally added as a specific component among the glass starting materials, and do not exclude mixing in as an impurity. This is also applied to the description, 0%, with regard to the glass composition.

When the total content of the alkali metal oxides selected from the group consisting of Li₂O, Na₂O, and K₂O—that is, the R₂O content (Li₂O+Na₂O+K₂O)—is less than 6%, the melting property and heat expansion characteristic of the glass decrease. At greater than 15%, the heat resistance decreases and chemical durability deteriorates. Accordingly, in the glass for a magnetic recording medium substrate according to an aspect of the present invention, the R₂O content is kept to 6 to 15%. The R₂O content desirably falls within a range of 7 to 15%, and is preferably 8 to 12%.

As set forth above, the incorporation of an excessive quantity of Li₂O causes a drop in heat resistance. The incorporation of an excessive quantity of Li₂O relative to Na₂O also tends to cause a drop in heat resistance. Thus, the quantity introduced is desirably adjusted relative to the quantity of Na₂O introduced so that the molar ratio of the Li₂O content to the Na₂O content (Li₂O/Na₂O) falls within a range of less than 0.50. From the perspective of inhibiting a drop in heat resistance while achieving the effects of introducing Li₂O, the molar ratio of (Li₂O/Na₂O) preferably falls within a range of greater than or equal to 0.005 and less than 0.50, more preferably falls within a range of 0.009 to 0.40, still more preferably falls within a range of 0.01 to 0.20, and yet more preferably, falls within a range of 0.01 to 0.10.

Since K₂O has a high atomic number serving to greatly lower thermal conductivity among the alkali metal oxides, and is disadvantageous from the perspective of chemical strengthening performance, the K₂O content is desirably limited relative to the total quantity of alkali metal oxides. Specifically, the molar ratio of the K₂O content to the total content of alkali metal oxides {K₂O/(Li₂O+Na₂O+K₂O)} is desirably less than or equal to 0.08. From the perspectives of chemical strengthening performance and thermal conductivity, the above molar ratio is preferably less than or equal to 0.06, more preferably less than or equal to 0.05, still more preferably less than or equal to 0.03, yet more preferably less than or equal to 0.02, yet still more preferably less than or equal to 0.01, and optimally, essentially zero. That is, K₂O is optimally not incorporated.

The glass for a magnetic recording medium substrate according to an aspect of the present invention contains MgO as an essential component. MgO has the effects of increasing the rigidity (Young's modulus) and enhancing the melting property of the glass. Further, the alkaline earth metal oxides MgO, CaO, SrO, and BaO have the effects of enhancing the melting property of the glass and increasing the coefficient of thermal expansion.

Although MgO is an essential component as set forth above, the incorporation of an excessive quantity tends to raise the liquidus temperature of the glass more than necessary and to lower the resistance to devitrification. Thus, the MgO content is desirably 8 to 30%, preferably 8 to 25%, more preferably 8 to 22%, still more preferably 10 to 22%, and yet still more preferably, falls within a range of 13 to 20%.

From the perspectives of enhancing the thermal expansion characteristic, raising the Young's modulus, and lowering the specific gravity, in one embodiment, the quantity of CaO incorporated is desirably 0 to 9%, preferably 0 to 5%, more preferably 0 to 2%, still more preferably 0 to 1%, and yet more preferably, falls within a range of 0 to 0.8%. It can essentially not be incorporated (that is, the CaO content can be 0%).

Although SrO is a component that enhances the thermal expansion characteristics, it increases the specific gravity more than MgO and CaO. Thus, the quantity incorporated is desirably less than or equal to 4 percent, preferably less than or equal to 3 percent, more preferably less than or equal to 2 percent, and still more preferably less than or equal to 1 percent. It can essentially not be incorporated (that is, the SrO content can be 0%).

To obtain a high glass transition temperature, from the perspective of a mixed alkaline earth effect, it is desirable to add just one alkaline earth metal oxide instead of multiple alkaline earth metal oxides. When adding multiple types, they can be selected so that the proportion of the alkaline earth metal oxide added in the greatest quantity is greater than or equal to 70 percent, preferably greater than or equal to 80 percent, more preferably greater than or equal to 90 percent, and still more preferably, greater than or equal to 95 percent of the total quantity of alkaline earth metal oxides.

BaO is an effective component for enhancing the melting property of the glass and not raising the devitrification temperature. However, BaO may react with carbonic gas in the atmosphere to form BaCO₃, a substance that adheres to the surface of the glass substrate. The substance causes damage of the head element of the magnetic memory device and the like. For such reasons, in the glass substrate according to the present invention, BaO is desirably essentially not incorporated (that is, the BaO content is desirably 0%).

When the total content of the alkaline earth metal oxides R′O (where R′ denotes Mg, Ca, Sr, or Ba) selected from the group consisting of MgO, CaO, SrO, and BaO—that is, the R′O content (MgO+CaO+SrO+BaO)—is excessively small, the glass rigidity drops and the thermal expansion characteristic deteriorates. When the R′O content is excessively large, although not to the degrees when R₂O is excessive, the glass transition temperature decreases and chemical durability deteriorates. From these perspectives, to achieve a high degree of rigidity, a high thermal expansion characteristic, and good chemical durability, in the glass for a magnetic recording medium substrate according to an aspect of the present invention, the R′O content falls within a range of 10 to 30%. The R′O content desirably falls within a range of 13 to 23%, and preferably falls within a range of 15 to 20%.

The quantities of alkali metal oxides and alkaline earth metal oxides incorporated have major impacts in achieving good heat resistance and a high degree of mechanical strength in the glass for a magnetic recording medium substrate. In particular, the ionic radii of the alkali metals and alkaline earth metals contribute to enhancing the chemical strengthening performance of glass with a high glass transition temperature, that is, high heat resistance.

When glass containing Li₂O and Na₂O is chemical strengthened by immersion in a mixed salt melt of sodium salt and potassium salt, Li⁺ ions in the glass undergo ion exchange with Na⁺ ions in the salt melt, and Na⁺ ions in the glass undergo ion exchange with K⁺ ions in the salt melt. A compressive stress layer is formed near the surface and a tensile stress layer is formed in the interior of the glass.

The glass for a magnetic recording medium substrate according to an aspect of the present invention has a high glass transition temperature of greater than or equal to 650° C., good heat resistance, and is suitable as a substrate material for use in a magnetic recording medium for forming a magnetic recording layer comprised of a high Ku magnetic material. In the high-temperature treatment and the like of magnetic materials, the glass substrate is exposed to elevated temperatures. However, if a glass material with a high glass transition temperature such as that set forth above is employed, the flatness of the substrate is not lost.

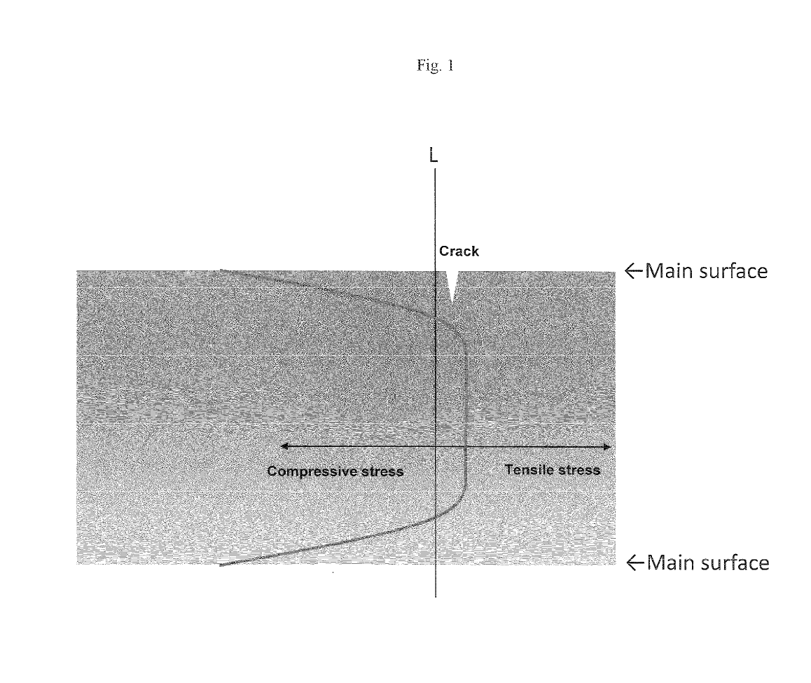

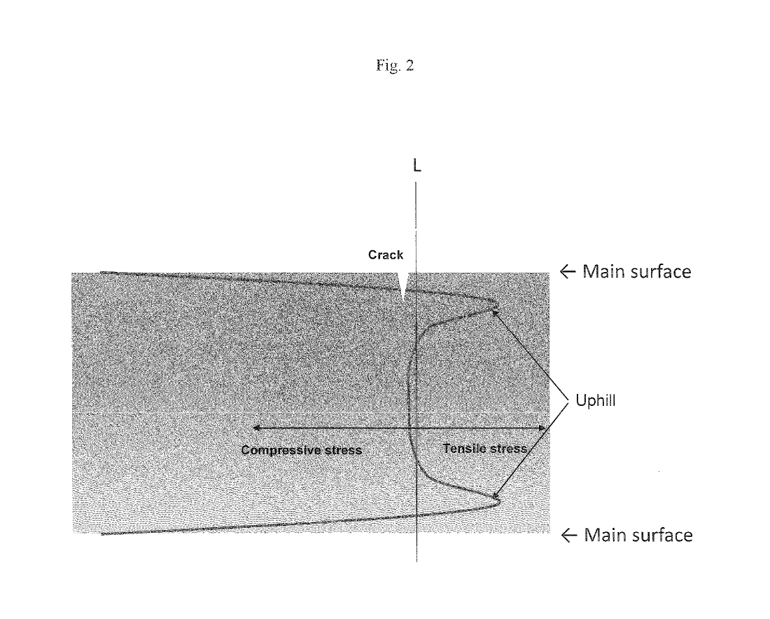

The diffusion rate of the alkali metal ions in the glass increases as the ion radius decreases. Thus, the Na⁺ ions in the salt melt penetrate to a deeper layer from the glass surface, forming a deep compressive stress layer. The K⁺ ions in the salt melt do not penetrate to as deep a layer as the Na⁺ ions, and form a compressive stress layer in a shallow portion from the surface. The stress distribution in the direction of depth of the glass that has been chemically strengthened by the mixed salts is comprised of a stress distribution formed by ion exchange between Na⁺ and Li⁺ and a stress distribution formed by ion exchange between K⁺ and Na⁺. Thus, the stress distribution in the direction of depth changes gradually. As shown in the schematic drawing of FIG. 1, in the stress profile in a virtual cross section perpendicular to the two main surfaces as measured by the Babinet method, the tensile stress distribution is convex in shape. This convex shape does not contain indentations that indent to the compressive stress side, as shown in FIG. 2, described further below. Further, a relative deep compressive stress layer is formed. In FIG. 1, there is a compressive stress region to the left of centerline L. The right side is the tensile stress region.

Even assuming that cracks open in the surface of the glass and reach the tensile stress layer, chemically strengthened glass with the above stress distribution would not immediately fracture.

In contrast, when chemically strengthening glass containing Na₂O and not containing Li₂O, immersing the glass in a potassium salt melt and causing the Na⁺ ions in the glass to exchange with the K ions in the salt melt would form a compressive stress layer in the vicinity of the glass surface. K⁺ ions have a lower diffusion rate than Na⁺ and Li⁺ ions and do not reach the deep layers of the glass. The compressive strength layer would be shallow, the stress distribution in the direction of depth would change abruptly, and as shown in the schematic diagram of FIG. 2, the spots near the sides of the two main surfaces and away from the center portion of the main surfaces would present maxima in the stress profile in a virtual cross section perpendicular to the two main surfaces as measured by the Babinet method. That is, the tensile stress would be maximal in two spots. Such maxima are referred to as “uphills.” In such a glass, if cracks were to form in the glass surface and reach the tensile stress layer, the ends of the cracks would reach the region of maximal tensile stress, and progression of the fractures would be exacerbated by the tensile stress, causing so-called “delayed fracturing.”

In the glass for a magnetic recording medium substrate according to an aspect of the present invention, since Li₂O and Na₂O are contained as glass components, chemical strengthening by a mixed salt of Na⁺ and K⁺ can prevent delayed fracturing. From the perspective of even more effectively preventing delayed fracturing, the Li₂O content is desirably greater than or equal to 0.05 percent.

By the way, when chemically strengthening glass with a high glass transition temperature, the strengthening treatment temperature also rises. When chemically strengthening glass with a high glass transition temperature, the drop in ion exchange efficiency that presents no problem in conventional glasses with relatively low glass transition temperatures becomes pronounced.

The present inventors conducted research on this point that resulted in the following discovery.

The ionic radii of the alkali metal ions Li⁺, Na⁺, and K⁺ and the alkaline earth metal ions Mg²⁺, Ca²⁺, Sr²⁺, and Ba²⁺ according to Pauling are given in Table 1.

TABLE 1

| Alkali metal ion | Ionic radius | Alkaline earth metal ion | Ionic radius |
|---|---|---|---|
| Li⁺ | 60 pm | Mg²⁺ | 65 pm |
| Na⁺ | 95 pm | Ca²⁺ | 99 pm |
| K⁺ | 133 pm | Sr²⁺ | 113 pm |
| | | Ba²⁺ | 135 pm |

As will be clear from Table 1, the ion radii of Li⁺ and Mg²⁺, Na⁺ and Ca²⁺, and K⁺ and Sr²⁺ have similar values. When the strengthening treatment temperature is raised, in addition to ion exchange between the alkali metal ions in the glass and in the salt melt, an ion exchange also takes place between the alkaline earth metal ions in the glass and the alkali metal ions in the salt melt. In particular, the rate of ion exchange between alkali metal ions and alkaline earth metal ions of similar ion radius values is thought to increase.

When chemically strengthening glass containing CaO at elevated temperature using a mixed salt melt of sodium salt and potassium salt, an ion exchange takes place between the Ca²⁺ in the glass and the Na⁺ in the salt melt in parallel with the ion exchange between the Na⁺ in the glass and the K⁺ in the salt melt. This is thought to block the exchanging of alkali metal ions.

As regards the Mg²⁺ in the glass, if a lithium salt melt is not employed, an ion exchange does not take place between the Mg²⁺ in the glass and Li⁺. Since the ionic radius of the Sr²⁺ in the glass is large and the dispersion rate is slow, exchange with the K⁺ in the salt melt tends not to occur.

MgO and CaO are components that are incorporated with preference. They are desirably incorporated in a total quantity of 10 to 30%. That is because when the total content of MgO and CaO is less than 10%, rigidity and the thermal expansion characteristic decrease, and when incorporated in excess of 30%, chemical durability drops. From the perspective of achieving good rigidity and thermal expansion characteristic effects by preferentially incorporating MgO and CaO, the total content of MgO and CaO desirably falls within a range of 10 to 25%, preferably within a range of 10 to 22%, more preferably falls within a range of 11 to 20%, and still more preferably, falls within a range of 12 to 20%.

In the glass for a magnetic recording medium substrate according to an aspect of the present invention, in order to resolve a drop in mechanical strength that is thought to be caused by a drop in the ion-exchange efficiency, being specific in the chemical strengthening of glass with a high degree of heat resistance, the ratio of MgO—an effective component for increasing the Young's modulus without compromising ion exchange efficiency—among the alkaline earth metal oxides is increased. That is, the molar ratio of the MgO content to the total content of MgO, CaO, SrO, and BaO (MgO/(MgO+CaO+SrO+BaO)) is kept greater than or equal to 0.80 to resolve the above-mentioned drop in mechanical strength. From the perspectives of maintaining ion-exchange efficiency and mechanical strength, the molar ratio of (MgO/(MgO+CaO+SrO+BaO)) desirably falls within a range of 0.85 to 1.00, preferably falls within a range of 0.90 to 1.00, and more preferably, falls within a range of 0.95 to 1.00.

By the way, the research group of the present inventors has made the discovery that when multiple types of glass components in the form of alkaline earth metal oxides are placed together, the glass transition temperature tends to drop. Based on this discovery, in terms of maintaining heat resistance, it is desirable to concentrate the alkaline earth metal oxides into a single type to the extent possible. That is, keeping the molar ratio of (MgO/(MgO+CaO+SrO+BaO)) within the above range is desirable also in terms of maintaining heat resistance.

As a desirable embodiment of the glass for a magnetic recording medium substrate according to an aspect of the present invention, to resolve the issue of the drop in mechanical strength thought to be caused by a drop in the ion-exchange efficiency, being specific in chemical strengthening of glass with a high degree of heat resistance, it is desirable to keep down the proportion of CaO—which decreases ion-exchange efficiency—among the alkaline earth metal oxides. That is, the molar ratio of the CaO content to the total content of MgO, CaO, SrO, and BaO (CaO/(MgO+CaO+SrO+BaO)) is desirably kept to less than or equal to 0.20. This makes it possible to resolve the issue of the above drop in mechanical strength. From the perspectives of maintaining ion-exchange efficiency and mechanical strength, the molar ratio of (CaO/(MgO+CaO+SrO+BaO)) desirably falls within a range of 0 to 0.18, preferably falls within a range of 0 to 0.16, more preferably falls within a range of 0 to 0.15, and still more preferably, falls within a range of 0 to 0.10.

Among the alkaline earth metal oxides, BaO plays the greatest role in maintaining a high glass transition temperature. However, as set forth above, it is desirable to essentially incorporate no BaO. It is desirable to keep the molar ratio of the total content of MgO and CaO to the total content of the alkaline earth metal oxides MgO, CaO, and SrO {(MgO+CaO)/(MgO+CaO+SrO)} to greater than or equal to 0.86 so as to not lower the glass transition temperature by not employing BaO. That is because for a given total quantity of alkaline earth metal oxides, rather than dividing up the total quantity among multiple alkaline earth metal oxides, the glass transition temperature can be kept higher by concentrating it in one or two types of alkaline earth metal oxides. That is, the drop in the glass transition temperature that is caused by not employing BaO can be kept down by keeping the above molar ratio to greater than or equal to 0.86. The fact that high rigidity (a high Young's modulus) is a characteristic required of a glass substrate has been set forth above. As set forth further below, a low specific gravity is a desirable characteristic that is required of a glass substrate. To achieve a higher Young's modulus and lower specific gravity, it is advantageous to preferentially incorporate MgO and CaO among the alkaline earth metal oxides. Accordingly, keeping the above molar ratio to greater than or equal to 0.86 is also effective in achieving a glass substrate with a higher Young's modulus and lower specific gravity. Based on the perspectives set forth above, the molar ratio of {(MgO+CaO)/(MgO+CaO+SrO)} is preferably kept to greater than or equal to 0.88, more preferably kept to greater than or equal to 0.90, still more preferably kept to greater than or equal to 0.93, yet more preferably kept to greater than or equal to 0.95, yet still more preferably kept to greater than or equal to 0.97, even more preferably kept to greater than or equal to 0.98, even yet more preferably kept to greater than or equal to 0.99, and optimally, made 1.

The total quantity of Li₂O, Na₂O, K₂O, MgO, CaO, and SrO (Li₂O+Na₂O+K₂O+MgO+CaO+SrO) is desirably 20 to 40%. That is because at greater than or equal to 20%, a good glass melting property, coefficient of thermal expansion, and rigidity can be maintained. At less than or equal to 40%, good chemical durability and heat resistance can be maintained. From the perspective of maintaining good levels of the above various characteristics, the above total content is preferably kept to within a range of 20 to 35%, more preferably to within a range of 21 to 33%, and still more preferably, kept to within a range of 23 to 30%.

As set forth above, MgO, CaO, and Li₂O are effective components for achieving high glass rigidity (a high Young's modulus). When the total of these three components is excessively low relative to the total of alkali metal oxides and alkaline earth metal oxides, it is difficult to raise the Young's modulus. Accordingly, in one embodiment, the quantities of MgO, CaO, and Li₂O that are incorporated are adjusted relative to the total of alkali metal oxides and alkaline earth metal oxides so that the molar ratio of the total content of MgO, CaO, and Li₂O to the total content of the alkali metal oxides and alkaline earth metal oxides {(MgO+CaO+Li₂O)/(Li₂O+Na₂O+K₂O+MgO, +CaO+SrO+MgO)} is greater than or equal to 0.50. The above molar ratio is desirably kept to greater than or equal to 0.55 and preferably kept to greater than or equal to 0.60 to further raise the Young's modulus of the glass substrate. From the perspective of the stability of the glass, the above molar ratio is desirably kept to less than or equal to 0.80, preferably less than or equal to 0.77, and more preferably, less than or equal to 0.75.

The glass for a magnetic recording medium substrate according to an aspect of the present invention can contain oxides selected from the group consisting of ZrO₂, TiO₂, Y₂O₃, La₂O₃, Gd₂O₃, Nb₂O₃, and Ta₂O₅. At least one component from among ZrO₂, TiO₂, Y₂O₃, La₂O₃, Gd₂O₃, Nb₂O₃, and Ta₂O₅ is desirably incorporated because they are components of increasing the rigidity and heat resistance. However, the incorporation of an excessive quantity compromises the glass melting property and coefficient of thermal expansion. Accordingly, the total content of the above oxides is desirably kept to within a range of greater than 0% and less than or equal to 10%, preferably within a range of 0.5 to 10%. The upper limit of the total content of the above oxides is preferably 9%, more preferably 8%, still more preferably 7%, yet more preferably 6%, yet still more preferably 3.5%, and even more preferably, 3%. The lower limit of the total content of the above oxides is preferably 1.5%, more preferably 2%. In one embodiment, the total content of the above oxides is preferably 2 to 10%, more preferably 2 to 9%, still more preferably 2 to 7%, and yet more preferably, falls within a range of 2 to 6%.

As set forth above, Al₂O₃ is also a component that increases rigidity and heat resistance. However, the above oxides raise the Young's modulus more. In one embodiment, the above oxides are incorporated in a molar ratio relative to Al₂O₃ of greater than or equal to 0.1—that is, the molar ratio of the total content of the above oxides to the content of Al₂O₃ of {(ZrO₂+TiO₂+Y₂O₃+La₂O₃+Gd₂O₃+Nb₂O₃+Ta₂O₅)/Al₂O₃}—is kept to greater than or equal to 0.10 to achieve increased rigidity and heat resistance. From the perspective of further enhancing rigidity and heat resistance, the above molar ratio is desirably kept to greater than or equal to 0.20, preferably kept to greater than or equal to 0.30. From the perspective of glass stability, the above molar ratio is desirably kept to less than or equal to 3.00, preferably less than or equal to 2.00, more preferably less than or equal to 1.00, still more preferably kept to less than or equal to 0.80, and yet more preferably, kept to less than or equal to 0.70.

B₂O₃ is a component that improves the brittleness of the glass substrate and enhances the melting property of the glass. However, when introduced in excessive quantity, heat resistance drops. Thus, in each glass set forth above, the quantity incorporated is desirable kept to 0 to 3%, preferably 0 to 2%, more preferably greater than or equal to 0% but less than 1%, and still more preferably, 0 to 0.5%. It is possible to essentially not incorporate any.

Cs₂O is a component that can be incorporated in small quantities so long as the desired characteristics and properties are not compromised. However, it increases the specific gravity more than other alkali metal oxides. Thus, it is possible to essentially not incorporate any.

ZnO is a component that improves the melting property, moldability, and stability of the glass, increases rigidity, and improves the heat expansion characteristic. However, when incorporated in excessive quantity, heat resistance and chemical durability decrease. Thus, the quantity incorporated is desirably kept to 0 to 3%, preferably 0 to 2%, and more preferably, 0 to 1%. It is possible to essentially not incorporate any.

ZrO₂ is a component that enhances chemical durability as well as improves rigidity and heat resistance as set forth above. However, when incorporated in excessive quantity, the melting property of the glass deteriorates. Thus, in one embodiment, the quantity incorporated is desirably kept to greater than 0% and less than or equal to 10%, preferably 1 to 10%. The upper limit of the ZrO₂ content is desirably 9%, preferably 8%, more preferably 7%, still more preferably 6%, yet more preferably 3.5%, and yet still more preferably, 3%. The lower limit of the content of ZrO₂ is desirably 1.5%, preferably 2%. In another embodiment, the quantity of ZrO₂ incorporated is desirably kept to 1 to 8%, preferably 1 to 6%, and more preferably, 2 to 6%.

TiO₂ is a component that inhibits an increase in the specific gravity of the glass, has the effect of enhancing rigidity, and thus, can raise the specific modulus of elasticity. However, when incorporated in excessive quantity, when the glass substrate comes in contact with water, it will sometimes produce a reaction product with water that deposits on the surface of the substrate. Thus, the quantity incorporated is desirably kept to 0 to 6%, preferably kept to 0 to 5%, more preferably kept to 0 to 3%, and still more preferably, kept to 0 to 2%.

Y₂O₃, Yb₂O₃, La₂O₃, Gd₂O₃, Nb₂O₅, and Ta₂O₅ are advantageous components from the perspectives of enhancing chemical durability, heat resistance, rigidity, and fracture toughness. However, when incorporated in excessive quantities, melting deteriorates and the specific gravity increases. Since it is also involves the use of expensive starting materials, their contents are desirably kept low. Accordingly, the total quantity of the above components incorporated is desirably kept to 0 to 3%, preferably kept to 0 to 2%, more preferably kept to 0 to 1%, still more preferably kept to 0 to 0.5%, and yet more preferably kept to 0 to 0.1%. When emphasizing enhanced melting, lower specific gravity, and cost reduction, they are desirably essentially not incorporated.

HfO₂ is also an advantageous component for enhancing chemical durability and heat resistance, and for increasing rigidity and fracture toughness. When incorporated in excessive quantity, the melting property deteriorates and the specific gravity increases. It is also involves the use of expensive starting materials. Thus, the content is desirably kept low. It is desirably essentially not incorporated.

Pb, As, Cd, Te, Cr, Tl, U, and Th are desirably essentially not incorporated, in view of impact on the environment.

From the perspective of increasing heat resistance and enhancing the melting property, the molar ratio of the total content of SiO₂, Al₂O₃, ZrO₂, TiO₂, Y₂O₃, La₂O₃, Gd₂O₃, Nb₂O₅, and Ta₂O₅ to the total content of alkali metal oxides (Li₂O, Na₂O, and K₂O) {(SiO₂+Al₂O₃+ZrO₂+TiO₂+Y₂O₃+La₂O₃+Gd₂O₃+Nb₂O+Ta₂O)/(Li₂O+Na₂O+K₂O)} desirably falls within a range of 3 to 15, preferably 3 to 12, more preferably 4 to 12, still more preferably, 5 to 12, yet more preferably 5 to 11, and yet still more preferably, within a range of 5 to 10.

Taking into account the characteristics of the various glass components set forth above, the following configuration is an example of a mode of implementing the glass for a magnetic recording medium substrate according to an aspect of the present invention having good heat resistance and a high degree of mechanical strength. That is, glass with a composition adjusted to have:

56 to 75 mol % of SiO₂;

1 to 20 mol % of Al₂O₃;

6 to 15 mol % of alkali metal oxides selected from the group consisting of Li₂O, Na₂O, and K₂O in total;

greater than 0 mol % and less than or equal to 3 mol % of Li₂O;

greater than or equal to 1 mol % and less than 15 mol % of Na₂O;

10 to 30 mol % of alkaline earth metal oxides selected from the group consisting of MgO, CaO, SrO, and BaO in total;

8 to 30 mol % of MgO;

greater than 0 mol % and less than or equal to 10 mol % of oxides selected from the group consisting of ZrO₂, TiO₂, Y₂O₃, La₂O₃, Gd₂O₃, Nb₂O₅, and Ta₂O₅ in total;

a molar ratio of the content of Li₂O to the total content of the above alkali metal oxides {Li₂O/(Li₂O+Na₂O+K₂O)} of greater than 0 and less than or equal to 0.3;

a molar ratio of the content of MgO to the total content of the above alkaline earth metal oxides {MgO/(MgO+CaO+SrO+BaO)} of greater than or equal to 0.80;

a glass transition temperature of greater than or equal to 650° C.; and

a Young's modulus of greater than or equal to 80 GPa

is desirable.

In an implementation mode of the glass for a magnetic recording medium substrate according to an aspect of the present invention, the glass the composition of which has been adjusted so as to satisfy at least one, desirably two or more, and preferably three or more from among:

an average coefficient of linear expansion at 100 to 300° C. of greater than or equal to 60×10⁻⁷/° C.;

a specific modulus of elasticity of greater than or equal to 30 MNm; and

a fracture toughness value of greater than or equal to 0.9 MPa·m^{1/2} is desirable.

In adjusting the composition, for example, the desirable range of the K₂O content in the above glass is as set forth above. Since BaO, one of alkaline earth metal oxides, serves to lower the fracture toughness, the upper limit of its content is desirably limited so that the fracture toughness value is greater than or equal to 0.9 MPa·m^{1/2}. The desirable range of the fracture toughness value is as set forth above. It suffices to limit the upper limit of the BaO content so that when employing a fracture toughness value obtained by measurement at a load of 4.9 N (500 gf), the fracture toughness value (load 4.9 N (500 gf)) exceeds 0.9 MPa·m^{1/2}. The desirable range of the fracture toughness value (load 4.9 N (500 gf)) is as set forth above. As stated above, it is possible to not incorporate BaO. In the case where the substrate according to an aspect of the present invention is a chemically strengthened glass substrate, at least a portion of the alkali metal atoms constituting the alkali metal oxide in the substrate are ion-exchanged. In the present invention, unless specifically stated otherwise, the same applies to the glass compositions with regard to chemically strengthened glass substrates.

One desirable embodiment of the magnetic recording medium substrate according to an aspect of the present invention is a glass substrate characterized by being subjected to chemical strengthening, that is, a chemically strengthened glass substrate. Chemical strengthening can further raise the fracture toughness value of the glass substrate. Chemical strengthening is desirably conducted with a melt of potassium nitrate or sodium nitrate, or a melt of potassium nitrate and sodium nitrate, to further raise the fracture toughness value. Glass components in the form of ion-exchangeable components, Li₂O and Na₂O, are incorporated into the glass of the present invention that has been chemically strengthened to obtain the glass substrate.

The glass substrate for a magnetic recording medium according to an aspect of the present invention has both a high degree of mechanical strength (including at least one from among a high Young's modulus, a high specific modulus of elasticity, and high fracture toughness) in addition to a high degree of heat resistance (a glass transition temperature of greater than or equal to 650° C.). Accordingly, the glass substrate according to an aspect of the present invention is suitably employed in magnetic recording devices having a rotational speed of greater than or equal to 5,000 rpm and of which high reliability is required, more suitably employed in magnetic recording devices having a rotational speed of greater than or equal to 7,200 rpm, and still more suitably employed in magnetic recording devices having a rotational speed of greater than or equal to 10,000 rpm.

Similarly, the substrate for a magnetic recording medium according to an aspect of the present invention is suitable for use in a magnetic recording device in which a DFH (dynamic flying height) head, high reliability of which is required, is mounted.

Another implementation mode of the glass for a magnetic recording medium substrate according to an aspect of the present invention will be given by way of example below.

That is, a glass the composition of which has been adjusted to have:

56 to 75 mol % of SiO₂;

1 to 20 mol % of Al₂O₃;

6 to 15 mol % of alkali metal oxides selected from the group consisting of Li₂O, Na₂O, and K₂O in total;

greater than 0 mol % and less than or equal to 3 mol % of Li₂O;

greater than or equal to 1 mol % and less than 15 mol % of Na₂O;

greater than or equal to 0 mol % and less than 3 mol % of K₂O;

10 to 30 mol % of alkaline earth metal oxides selected from the group consisting of MgO, CaO, and SrO in total;

8 to 30 mol % of MgO;

essentially no BaO;

a molar ratio of the content of Li₂O to the total content of the above alkali metal oxides {Li₂O/(Li₂O+Na₂O+K₂O)} of greater than 0 and less than or equal to 0.3;

a molar ratio of the content of MgO to the total content of the above alkaline earth metal oxides {MgO/(MgO+CaO+SrO)} of greater than or equal to 0.80; and

a molar ratio of the content of K₂O to the total content of the above alkali metal oxides {K₂O/(Li₂O+Na₂O+K₂O)} of less than or equal to 0.08

is desirable.

In the above glass for a magnetic recording medium substrate, the molar ratio of the total content of MgO and CaO to the total content of the alkaline earth metal oxides {(MgO+CaO)/(MgO+CaO+SrO)} is desirably greater than or equal to 0.86. The molar ratio of the total content of MgO, CaO, and Li₂O to the total content of Li₂O, Na₂O, K₂O, MgO, CaO, and SrO {(MgO+CaO+Li₂O)/(Li₂O+Na₂O+K₂O+MgO+CaO+SrO)} is desirably greater than or equal to 0.50.

The total content of oxides selected from the group consisting of ZrO₂, TiO₂, Y₂O₃, La₂O₃, Gd₂O₃, Nb₂O₅, and Ta₂O₅ in the above glass for a magnetic recording medium substrate is desirably greater than 0% and less than or equal to 10%. Further, the glass is desirably one in which the molar ratio of the total content of the above oxides to the Al₂O₃ content {(ZrO₂+TiO₂+Y₂O₃+La₂O₃+Gd₂O₃+Nb₂O₅+Ta₂O₅)/Al₂O₃} is greater than or equal to 0.30.

In the glass for a magnetic recording medium substrate having the glass composition given by way of example above, an ion-exchange layer can be formed on the glass surface by a chemical strengthening treatment.

(Glass Manufacturing Method)

The glass for a magnetic recording medium substrate according to an aspect of the present invention can be obtained, for example, by weighing out starting materials such as oxides, carbonates, nitrates, and hydroxides in a manner calculated to yield the glass of the above composition; mixing to obtain a blended starting material; charging the blended starting material to a melting vessel; heating to within a range of 1,400 to 1,600° C.; melting, clarifying, and stirring the mixture to remove bubbles and unmelted material and obtain a homogenous glass melt; and molding the glass melt. The glass melt can be molded by the press molding method, casting method, float method, overflow down draw method, or the like. In the press molding method, the glass melt can be pressed and molded into a disk shape, making this method suitable for molding blanks for use as magnetic recording media substrates.

Among press molding methods, the method of causing a quantity of glass melt corresponding to one substrate blank to drop down and press molding the glass melt in the air is desirable. In this method, the glass melt in the air is sandwiched and pressed by a pair of pressing molds. Thus, the glass can be uniformly cooled through the surfaces that come into contact with the various pressing molds, allowing the manufacturing of a substrate blank of good flatness.

(Chemically Strengthened Glass)

The glass for a magnetic recording medium substrate according to an aspect of the present invention is suitable as glass for chemical strengthening.

Since adjustment of the above-described composition imparts good chemical strengthening performance, an ion-exchange layer can be readily formed in the outer surface of the glass by a chemical strengthening treatment, forming an ion-exchange layer over part or all of the outer surface. The ion-exchange layer can be formed by bringing an alkali salt into contact with the substrate surface under high temperature and causing the alkali metal ions in the alkali salt to exchange with the alkali metal ions in the substrate.

In the usual ion exchange, an alkali nitrate is heated to obtain a salt melt, and the substrate is immersed in the salt melt. When the alkali metal ions with small ion radii in the substrate are replaced with the alkali metal ions of larger ion radii in the salt melt, a compressive stress layer is formed in the surface of the substrate. That increases the fracture toughness of the magnetic recording medium-use glass substrate, making it possible to increase reliability.

Chemical strengthening can be conducted by immersing the glass, that may be preprocessed as needed, in a mixed salt melt containing, for example, a sodium salt and a potassium salt. Sodium nitrate is desirably employed as the sodium salt and potassium nitrate as the potassium salt. The glass for a magnetic recording medium substrate of the present invention contains Li₂O as an essential component as set forth above, so the ion exchange is desirably conducted with Na and K, which have larger ion radii than Li.

The quantity of alkali leaching out of the chemically strengthened glass surface can also be reduced by ion exchange. In the case of chemical strengthening, the ion exchange is desirably conducted within a temperature range that is greater than the strain point of the glass constituting the substrate, lower than the glass transition temperature, and in which the alkali salt melt does not undergo thermal decomposition. The fact that an ion-exchange layer is present in the substrate can be confirmed by the method of observing a cross section of the glass (a plane cutting through the ion-exchange layer) by the Babinet method, by the method of measuring the concentration distribution in the direction of depth of the alkali metal ions from the surface of the glass, and the like.

The strengthening treatment temperature (temperature of the salt melt) and the strengthening processing time (the time during which the glass is immersed in the salt melt) can be suitably adjusted. For example, the range of the strengthening treatment temperature can be adjusted with 400 to 570° C. as a goal. The range of the strengthening processing time can be adjusted with 0.5 to 10 hours as a goal, desirably with 1 to 6 hours as a goal.

Since the glass transition temperature, thermal expansion coefficient, Young's modulus, specific modulus of elasticity, specific gravity, and spectral transmittance are values that remain nearly constant before and after chemical strengthening, the various characteristics of the thermal expansion coefficient, Young's modulus, specific modulus od elasticity, specific gravity, and spectral transmittance before and after chemical strengthening are treated as identical values in the present invention. The glass in an amorphous state maintains an amorphous state after chemical strengthening.

The glass for a magnetic recording medium substrate according to an aspect of the present invention can exhibit the stress profile set forth above when subjected to chemical strengthening, thereby preventing the occurrence of delayed fracturing. Accordingly, the glass substrate for a magnetic recording medium of the present invention that is obtained by chemically strengthening the glass according to an aspect of the present invention is a glass substrate that tends not to undergo delayed fracturing, and has high heat resistance and good mechanical strength. It can exhibit the various advantages of the glass obtained by chemically strengthening the above-described glass for a magnetic recording medium substrate.

The magnetic recording medium substrate according to an aspect of the present invention can be a glass substrate comprised of chemically strengthened glass in which a tensile stress distribution is convex in shape such that the convex shape does not contain indentations indenting to a compressive stress side in a stress profile in a virtual cross section perpendicular to two main surfaces as obtained by the Babinet method. The stress profile is as set forth above. By exhibiting such a stress profile, it is possible to prevent the generation of delayed fractures. For example, when the depth from the main surface is denoted by x in the virtual cross section, the stress value S(x) at depth x is called the stress profile. The stress profile is normally linearly symmetric at the center between the two main surfaces. To determine the stress profile, it suffices to fracture the glass substrate perpendicularly to the two main surfaces and observe the fracture plane by the Babinet method.

As an embodiment of a desirable stress profile, the compressive stress value becomes a maximum in the vicinity of the two main surfaces, and the compressive stress value decreases as depth x increases. At depths beyond depth x₀, which is where the compressive stress and the tensile stress balance out, the compressive stress turns into tensile stress, and the tensile stress gradually increases, reaching a peak value at or in the vicinity of the midpoint between the two main surfaces. As shown in FIG. 1, the peak value will sometimes be maintained over a fixed region in the direction of depth. In a glass substrate that adopts such a stress profile, even if the depth of a crack that occurs on the substrate surface were to exceed x₀, it would be possible to prevent delayed fracturing where tensile stress causes the crack to grow rapidly to where fracturing occurs.

The magnetic recording medium substrate according to an aspect of the present invention can be a glass substrate comprised of a chemically strengthened glass in which an average value Tav of a tensile stress obtained by the Babinet method and a maximum value Tmax of the tensile stress satisfy the following expression (1):

Tav/Tmax≧0.4 (1).

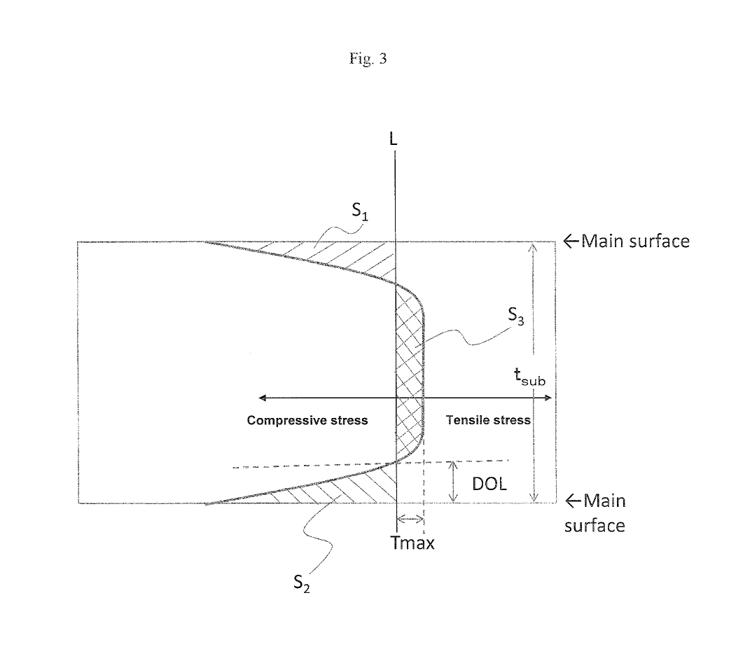

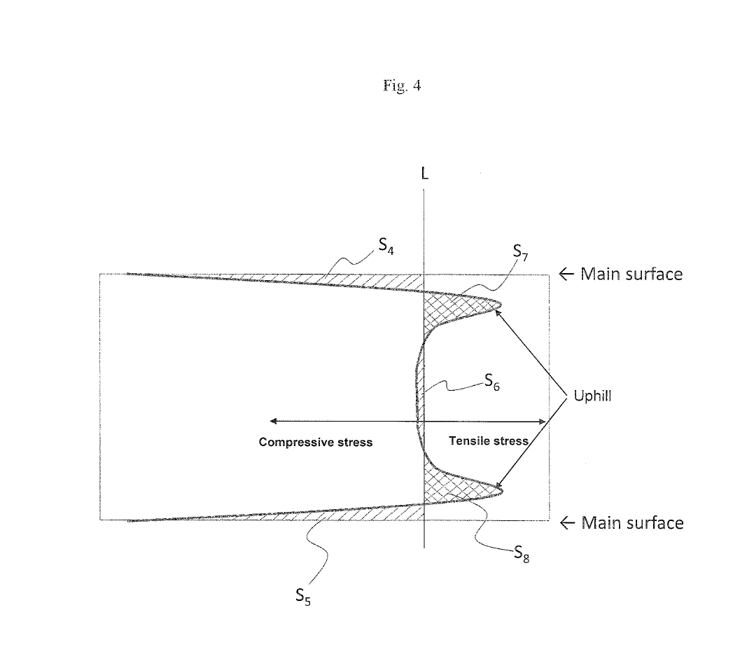

Expression (1) will be described below based on FIGS. 3 and 4.

Maximum value Tmax of the tensile stress is the peak value of the above tensile stress. In FIG. 3, the average value Tv of the tensile stress, line L—the centerline of the tensile stress and the compressive stress—is determined such that surface areas S₁, S₂, and S₃ satisfy S₁+S₂=S₃. Denoting the distance from the point of intersection of a virtual straight line parallel to the main surface on the S₂ side and a virtual line perpendicular to the two main surfaces and passing through Tmax to the main surface on the S₂ side as DOL, the average value Tav of the tensile stress is given by Tav=S₃/(tsub−2×DOL).

It is satisfied that Tav/Tmax≧0.4, desirable that Tav/Tmax≧0.5, and preferable that Tav/Tmax≧0.7. The upper limit of Tav/Tmax can be, for example, Tav/Tmax<1.0.

Tav/Tmax, specified by expression (1), can be employed as an indicator that no uphill, such as that shown in FIG. 2 and described above, is present. A glass substrate in which an uphill is present will have a large Tmax, making Tav/Tmax<0.4. By contrast, no uphill will be present in a glass satisfying the above expression (1), so the generation of delayed fractures will be inhibited.

In a glass substrate in which uphills are present as shown in FIG. 2, line L will be determined, as shown in FIG. 4, such that surface areas S₄, S₅, S₆, S₇, and S₈ satisfy S₄+S₅+S₆=S₇+S₈. Tav is then calculated as Tav=(S₇+S₈−S₆)/(tsub−2×DOL). In FIG. 2, the tensile stress layer is divided into the two layers of S₇ and S₈ by S₆. As shown in FIG. 1, when the tensile stress layer is comprised of a single layer, Tav can be calculated as Tav=S₃/(tsub−2×DOL), as set forth above.

A further aspect of the present invention relates to:

a magnetic recording medium substrate blank comprised of the glass for a magnetic recording medium substrate according to an aspect of the present invention; and

a method of manufacturing a magnetic recording medium, which includes processing the above magnetic recording medium substrate blank.

In this connection, the magnetic recording medium substrate blank (referred to as the “substrate blank”, hereinafter) means a substrate-use glass base material prior to finishing into a glass substrate for a magnetic recording medium by processing. The composition, characteristics, and desirable ranges of the composition and characteristics of the glass constituting the substrate blank are as set above.

Since the glass substrate for a magnetic recording medium is disk-shaped, the substrate blank according to an aspect of the present invention is desirably disk-shaped.

The substrate blank can be fabricated by blending glass starting materials in a manner calculated to yield the above glass; melting them to obtain a glass melt; molding the glass melt thus fabricated into sheet form by any method such as press molding, the down draw method, or the float method; and processing the glass sheet obtained as needed.

In the press molding method, an outflowing glass melt is cut to obtain a desired molten glass gob. The molten glass gob is press molded in a pressing mold to fabricate a thin, disk-shaped substrate blank.

A further aspect of the present invention relates to a magnetic recording medium having a magnetic recording layer on a magnetic recording medium substrate according to an aspect of the present invention.

The magnetic recording medium according to an aspect of the present invention will be described in greater detail below.

For example, the magnetic recording medium according to an aspect of the present invention can be a disk-shaped magnetic recording medium (called as a magnetic disk, hard disk, or the like) having a structure sequentially comprised of, moving outward from the main surface, at least an adhesive layer, an undercoat layer, a magnetic layer (magnetic recording layer), a protective layer, and a lubricating layer laminated on the main surface of a glass substrate.

For example, the glass substrate is introduced into a film-forming device within which a vacuum has been drawn, and the adhesive layer through the magnetic layer are sequentially formed on the main surface of the glass substrate in an Ar atmosphere by the DC magnetron sputtering method. The adhesive layer may be in the form of, for example, CrTi, and the undercoat layer may be in the form of, for example, CrRu. Following the forming of these films, the protective layer may be formed using C₂H₄ by the CVD method, for example. Within the same chamber, nitriding can be conducted to incorporate nitrogen into the surface to form a magnetic recording medium. Subsequently, for example, PFPE (polyfluoropolyether) can be coated over the protective layer by the dip coating method to form a lubricating layer.

Further, a soft magnetic layer, seed layer, intermediate layer, or the like can be formed between the undercoat layer and the magnetic layer by a known film-forming method such as sputtering method (including DC magnetron sputtering method, RF magnetron sputtering method, or the like) or vacuum vapor deposition.

Reference can be made, for example, to paragraphs [0027] to [0032] of Japanese Unexamined Patent Publication (KOKAI) No. 2009-110626, which is expressly incorporated herein by reference in its entirety. A heat sink layer comprised of a material of high thermoconductivity can be formed between the glass substrate and the soft magnetic layer, the details of which are given further below.

As set forth above, to achieve higher density recording on a magnetic recording medium, the magnetic recording layer is desirably formed of a magnetic material of high Ku. To that end, Fe—Pt-based magnetic materials, Co—Pt-based magnetic material, or Fe—Co—Pt-based magnetic materials are desirable magnetic material. In this context, the word “based” means “containing”. That is, the magnetic recording medium of the present invention desirably has a magnetic recording layer containing Fe and Pt, Co and Pt, or Fe, Co, and Pt. For example, in contrast to the film-forming temperature of about 250 to 300° C. for magnetic materials that have conventionally been commonly employed, such as Co—Cr based materials, the film-forming temperature for the above magnetic material is an elevated temperature exceeding 500° C. These magnetic materials are normally subjected to a high-temperature heat treatment (annealing) at a temperature exceeding the film-forming temperature to align the crystal orientation following film formation. Accordingly, when employing an Fe—Pt based magnetic material, Co—Pt based magnetic material, or an Fe—Co—Pt based magnetic material to form the magnetic recording layer, the substrate is exposed to the above elevated temperature. When the glass constituting the substrate is one with poor heat resistance, it will deform at elevated temperature, losing its flatness. By contrast, the substrate contained in the magnetic recording medium of the present invention exhibits good heat resistance (a glass transition temperature of greater than or equal to 650° C.). Thus, even after using an Fe—Pt based magnetic material, Co—Pt based magnetic material, or Fe—Co—Pt based magnetic material to form the magnetic recording layer, the substrate can retain a high degree of flatness. The magnetic recording layer can be formed, for example, in an Ar atmosphere by forming a film of a Fe—Pt based magnetic material, Co—Pt based magnetic material, or Fe—Co—Pt based magnetic material by the DC magnetron sputtering method, and then subjecting it to a high-temperature heat treatment in a heating furnace.

The Ku (crystal magnetic anisotropy constant) is proportional to the coercivity He. “Coercivity He” denotes the strength of the magnetic field that reverses the magnetization. As set forth above, magnetic materials of high Ku have resistance to thermal fluctuation. Thus, they are known to be materials in which magnetized regions tend not to deteriorate due to thermal fluctuation, even when extremely minute magnetic particles are employed, and are thus suited to high-density recording. However, since Ku and He are proportional, as stated above, the higher the Ku, the higher the He. That is, the reversal of magnetization by the magnetic head tends not to occur and the writing of information becomes difficult. Accordingly, the recording method of assisting the reversal of magnetization of a magnetic material of high Ku by instantaneously applying energy to the data writing region through the head to lower the coercivity when writing information with a magnetic head has gathered attention in recent years.

Such recording methods are referred to as “energy-assisted recording methods.” Among them, the recording method of assisting the reversal of magnetization by irradiating a laser beam is referred to as the “heat-assisted recording method,” and the recording method that provides assistance by means of microwaves is referred to as the “microwave-assisted recording method”. As set forth above, an aspect of the present invention permits the formation of a magnetic recording layer with a magnetic material of high Ku. Thus, by combining a magnetic material of high Ku with energy-assisted recording, for example, it is possible to achieve high-density recording in which the surface recording density exceeds one terabyte/inch². That is, the magnetic recording medium according to an aspect of the present invention is preferably employed in an energy-assisted recording method. Heat-assisted recording methods are described in detail, for example, in IEEE Transactions on Magnetics, Vol. 44, No. 1, January 2008 119, and microwave-assisted recording methods are described in detail in, for example, IEEE Transactions on Magnetics, Vol. 44, No. 1, January 2008 125. Energy-assisted recording can also be conducted in an aspect of the present invention by the methods described in these documents. The above publications are expressly incorporated herein by reference in their entireties.

The dimensions of the magnetic recording medium substrate (such as a glass substrate for a magnetic disk) and magnetic recording medium (such as a magnetic disk) according to an aspect of the present invention are not specifically limited. For example, the medium and the substrate can be made small because high-density recording is possible. For example, a nominal diameter of 2.5 inches is naturally possible, as are smaller diameters (such as 1 inch and 1.8 inches), or dimensions such as 3 inches and 3.5 inches.

The method of manufacturing a magnetic recording medium substrate will be described next.

First, glass starting materials such as oxides, carbonates, nitrates, sulfates, and hydroxides are weighed out in a manner calculated to yield the desired glass composition and blended. The blend is thoroughly mixed; heated and melted in a melting vessel at a range of 1,400 to 1,600° C., for example; and clarified and thoroughly stirred to remove bubbles and fabricate a homogenized glass melt free of bubbles. As needed, a clarifying agent can be added to the glass starting material based on a ratio relative to the total of the other components. As clarifying agents, Sn oxides and Ce oxides are desirably employed as clarifying agents. The reasons for this are given below.

At elevated temperature during melting of the glass, Sn oxides tend to release oxygen gas. Minute bubbles that are contained in the glass are picked up and converted into large bubble, which tend to rise, thereby achieving a good clarifying action. Additionally, Ce oxides pick up as a glass component oxygen that is present as a gas in the glass at low temperature, thereby achieving a good clarifying action. At a bubble size of less than or equal to 0.3 mm (the size of bubbles (voids) remaining in the solidified glass), the action of Sn oxides in eliminating both relatively large bubbles and extremely small bubbles is powerful. When a Ce oxide is added in combination with an Sn oxide, the density of bubbles of about 50 μm to 0.3 mm in size is reduced to about one part in several tens. Thus, by combining an Sn oxide and a Ce oxide, it is possible to increase the glass clarifying effect over a broad temperature range from the high temperature range to the low temperature range. It is for that reason that the addition of an Sn oxide and a Ce oxide is desirable.

When the total quantity of Sn oxide and Ce oxide that is added relative to the total of the other components is greater than or equal to 0.02 mass percent, an adequate clarifying effect can be anticipated. When a substrate is prepared using glass containing even trace or small quantities of unmelted material, and the unmelted material appears on the surface of the substrate due to polishing, protrusions are generated on the substrate surface and portions where the unreacted material drops out become pits. The smoothness of the substrate surface is lost, and the substrate cannot be used in a magnetic recording medium. By contrast, when the total quantity of Sn oxide and Ce oxide added relative to the total of the other components is less than or equal to 3.5 mass percent, they can dissolve adequately into the glass and prevent the incorporation of unmelted material.

The quantity of a given component (referred to as “component A”, hereinafter) that is added relative to the total of the other components means the content of component A denoted as a mass percent when the total of the contents of glass components other than component A is adopted as 100 mass percent. Accordingly, the quantity of Sn oxide that is added relative to the total of the other components means the content of Sn oxide denoted as a mass percent when the total of the contents of all glass components other than Sn oxide is adopted as 100 mass percent. The content of Ce oxide that is added relative to the total of the other components means the content of Ce oxides denoted as a mass percent when the total of the contents of all glass components other than Ce oxides is adopted as 100 mass percent. The total quantity of Sn oxide and Ce oxide added relative to the total of the other components means the total of the quantity of Sn oxide added relative to the total of the other components and the quantity of Ce oxide added relative to the total of the other components.

When preparing crystallized glass, Sn and Ce function to produce crystal nuclei. Since the glass substrate according to an aspect of the present invention is comprised of amorphous glass, it is desirable not to cause crystals to precipitate by heating. When the quantities of Sn and Ce are excessive, such precipitation of crystals tends to occur. Thus, the addition of an excessive quantity of Sn oxide or Ce oxide is to be avoided.

From the above perspectives, the total quantity of Sn oxide and Ce oxide added relative to the total of the other components is desirably 0.02 to 3.5 mass percent. The total quantity of Sn oxide and Ce oxide added relative to the total of the other components preferably falls within a range of 0.1 to 2.5 mass percent, more preferably a range of 0.1 to 1.5 mass percent, and still more preferably, within a range of 0.5 to 1.5 mass percent.

The use of SnO₂ as the Sn oxide is desirable to effectively release oxygen gas from the glass melt at high temperature.

Sulfates can also be added as clarifying agents in a range of 0 to 1 mass percent relative to the total of the other components. However, they present the risk that melted material will boil over in the glass melt, causing foreign matter to increase sharply in the glass. When this boiling over is a concern, it is desirable not to incorporate sulfates. So long as the object of the present invention is not lost and a clarifying effect is achieved, clarifying agents other than those set forth above can be employed. However, the addition of As is to be avoided due to the great environmental burden it creates, as set forth above. Similarly, it is better to not employ Sb in light of the environmental burden it imposes.

The glass melt that has been prepared is molded into sheet form by a method such as press molding, the down draw method, or the float method and the sheet of glass obtained is subjected to a processing step to obtain the molded glass article in the shape of a substrate, that is, the magnetic recording medium substrate blank according to an aspect of the present invention.

In the press molding method, an outflowing glass melt is cut to obtain a desired molten glass gob. This glass gob is then press molded in a pressing mold to fabricate a thin, disk-shaped substrate blank.

In the down draw method, a trough-shaped forming body is used to guide the glass melt. When the glass melt reaches the two ends of the forming body, it overflows. The two glass melt flows that flow down along the forming body rejoin beneath the forming body, stretching downward to form a sheet. This method is also called the fusion method. By joining together the surfaces of the glass that has contacted the surface of the forming body, it is possible to obtain a glass sheet that is free of contact marks. Subsequently, thin, disk-shaped substrate blanks are cut out of the sheet material obtained.

In the float method, the glass melt is caused to flow out onto a float bath of molten tin or the like, and is molded into a sheet of glass as it spreads. Subsequently, thin, disk-shaped substrate blanks are cut out of the sheet material obtained.

A center hole is provided in the substrate blank thus obtained, the inner and outer circumferences thereof are processed, and the two main surfaces are lapped and polished. Next, a cleaning step comprising acid washing and alkali washing can be conducted to obtain a disk-shaped substrate.

The method of manufacturing a magnetic recording medium substrate according to an aspect of the present invention can also comprise a step of polishing a glass material with a fracture toughness value K_{1c} lower than 1.3 MPa·m^{1/2} and a chemical strengthening step following the polishing step.

In mechanical processing such as polishing, glasses of low fracture toughness are easier to process. Accordingly, in the method of manufacturing a magnetic recording medium substrate according to an aspect of the present invention, it is possible to readily manufacture a glass substrate with a high fracture toughness value and good impact resistance by conducting chemical strengthening to raise the fracture toughness following mechanical processing of the glass material with a fracture toughness value K_{1c} lower than 1.3 MPa·m^{1/2}. The fracture toughness value can be kept to a desired value mainly by means of the chemical strengthening conditions. It is also possible to raise the fracture toughness value by intensifying the chemical strengthening conditions (for example, lengthening the processing period).

The fracture toughness value prior to chemical strengthening of the above glass material is desirably less than or equal to 1.2 MPa·m^{1/2}, preferably less than or equal to 1.1 MPa·m^{1/2}, more preferably less than or equal to 1.0 MPa·m^{1/2}, still more preferably less than or equal to 0.9 MPa·m^{1/2}, and yet still more preferably, less than or equal to 0.8 MPa·m^{1/2}.

In the method of manufacturing a magnetic recording medium substrate according to an aspect of the present invention, an additional polishing step can be conducted following the chemical strengthening step. One desirable embodiment of the method of manufacturing a magnetic recording medium substrate according to an aspect of the present invention is a method of manufacturing a glass substrate for a magnetic recording medium, which comprises a chemical strengthening step that is characterized in that, in the chemical strengthening step, the ratio of the fracture toughness value K_{1c} (after) of the glass material following chemical strengthening to the fracture toughness value K_{1c} (before) of the glass material before chemical strengthening (K_{1c} (after)/K_{1c} (before)) is greater than or equal to 1.5. In this method, a glass material having a fracture toughness value suited to mechanical processing is chemically strengthened after mechanical processing such as polishing to increase the fracture toughness value. By making the ratio (K_{1c} (after)/K_{1c} (before)) greater than or equal to 1.5, or even greater than or equal to 1.7, it is possible to readily manufacture a magnetic recording medium substrate with good impact resistance. The K_{1c} (before) and K_{1c} (after) in the method of manufacturing a magnetic recording medium substrate according to an aspect of the present invention are fracture toughness values that are both measured for the same loads. When K_{1c} (before) is measured at a load of 9.81 N (1,000 gf), K_{1c} (after) is also measured at a load of 9.81 N (1,000 gf). When K_{1c} (before) is measured at a load of 4.9 N (500 gf), K_{1c} (after) is also measured at a load of 4.9 N (500 gf).

In the fabrication of a chemically strengthened glass substrate, the B₂O₃ that is contained as a glass component increases K_{1c} (before) and reduces the mechanical processability prior to chemical strengthening without contributing to improving chemical strengthening performance. Thus, to obtain a glass with a high ratio of K_{1c} (after)/K_{1c} (before), it is desirable to limit the content of B₂O₃ to within a range of 0 to 3 percent, preferably to within a range of 0 to 2 percent, more preferably to within a range of greater than or equal to 0 percent but less than 1 percent, and still more preferably to within a range of 0 to 0.5 percent. Substantially not incorporating any is desirable. The fracture strength value K_{1c} (before) prior to chemical strengthening is a value that is measured after the polishing step.

The magnetic recording medium substrate according to an aspect of the present invention can be comprised of glass obtained by chemically strengthening glass with a molar ratio of the K₂O content to the total content of alkali metal oxides {K₂O/(Li₂O+Na₂O+K₂O)} of less than or equal to 0.08 and having a glass transition temperature of greater than or equal to 650° C. and a fracture toughness value of greater than or equal to 0.9 MPa·m^{1/2}.

The magnetic recording medium substrate according to an aspect of the present invention can be comprised of glass having a glass transition temperature of greater than or equal to 620° C., a Young's modulus of greater than or equal to 80 GPa, a specific modulus of elasticity of greater than or equal to 30 MNm/kg, and a fracture toughness value of greater than or equal to 0.9 MPa·m^{1/2}.

Magnetic recording media that are 2.5 inches in outer diameter are normally employed in the HDDs of laptop computers. The glass substrate employed therein has conventionally been 0.635 mm in plate thickness. However, with the goals of increasing the substrate rigidity to improve the impact resistance without changing the specific modulus of elasticity, it is desirable to employ a plate thickness of greater than or equal to 0.7 mm, preferably a plate thickness of greater than or equal to 0.8 mm, for example.

The main surfaces on which the magnetic recording layer is formed desirably have the surface properties of (1) to (3) below:

(1) An arithmetic average Ra of surface roughness measured at a resolution of 512×256 pixels over an area of 1 μm×1 μm by an atomic force microscope of less than or equal to 0.15 nm;

(2) An arithmetic average Ra of surface roughness measured over an area of 5 μm×5 μm by an atomic force microscope of less than or equal to 0.12 nm;

(3) An arithmetic average Wa of surface undulation at wavelengths of 100 μm to 950 μm of less than or equal to 0.5 nm.

The grain size of the magnetic recording layer that is formed on the substrate is, for example, less than 10 nm in the perpendicular recording method. When the surface roughness of the substrate surface is great, no improvement in magnetic characteristics can be anticipated even when the bit size is reduced to achieve high-density recording. By contrast, in a substrate in which the arithmetic average Ra of the two types of surface roughness of (1) and (2) are within the above-stated ranges, it is possible to improve magnetic characteristics even when the bit size is reduced to achieve high-density recording. By keeping the arithmetic average Wa of surface undulation of (3) above within the above-stated range, it is possible to improve the flying stability of the magnetic head in a HDD. Increasing the acid resistance and alkali resistance of the glass is effective for achieving a substrate having surface properties (1) to (3) above.

The magnetic recording medium according to an aspect of the present invention is called as a magnetic disk, hard disk, or the like. It is suited to application to the internal memory apparatuses (fixed disks and the like) of desktop computers, server-use computers, laptop computers, mobile computers, and the like; the internal memory apparatuses of portable recording and reproduction devices that record and reproduce images and/or sound; vehicle-mounted audio recording and reproduction devices; and the like. It is also particularly suited to energy-assisted recording systems, as set forth above.

The magnetic recording device will be described next.

The magnetic recording device according to an aspect of the present invention is a magnetic recording device of energy-assisted magnetic recording system, which comprises a heat-assisted magnetic recording head having a heat source to heat at least a main surface of a magnetic recording medium, a recording element member, and a reproduction element member, and the magnetic recording medium of the present invention.

An aspect of the present invention can provide a magnetic recording device of high recording density that is highly reliable by mounting the magnetic recording medium according to an aspect of the present invention.

Since the magnetic recording device is equipped with a substrate of high strength, adequate reliability is afforded at a high rotational speed of greater than or equal to 5,000 rpm, desirably greater than or equal to 7,200 rpm, and preferably, greater than or equal to 10,000 rpm.

Further, a DFH (Dynamic Flying Height) head is desirably mounted in the magnetic recording device to achieve high recording density.

Examples of the magnetic recording device are the internal memory devices (fixed disks and the like) of various computers such as desktop computers, server-use computers, laptop computers, and mobile computers; the internal memory devices of portable recording and reproduction devices that record and reproduce images and/or sound; and vehicle-mounted audio recording and reproduction device.

### Examples

The present invention is described in greater detail below through Examples. However, the present invention is not limited to the embodiments shown in Examples.

(1) Preparation of Glass Melts

Oxides, carbonates, nitrates, hydroxides, and other starting materials were weighed out and mixed in a manner calculated to yield glasses of the various compositions of Nos. 1 to 22 (Examples) shown in Tables 2 to 6 and No. 23 (Comparative Example) shown in Table 7 to obtain blended starting materials. Each of the starting materials was charged to a melting vessel, heated, melted clarified, and stirred for 3 to 6 hours within a range of 1,400 to 1,600° C. to prepare a homogeneous glass melt free of bubbles and unmelted materials. No bubbles, unmelted materials, crystal precipitation, or contaminants in the form of refractory materials constituting the melting vessel were found in the glasses Nos. 1 to 22 that were obtained.

(2) Preparation of Substrate Blanks

Next, disk-shaped substrate blanks were prepared by methods A or B below.

### (Method A)

The above glass melt that had been clarified and homogenized was caused to flow out of a pipe at a constant flow rate and received in the lower mold of a pressing mold. The outflowing glass melt was cut with a cutting blade to obtain a glass melt gob of prescribed weight on the lower mold. The lower mold carrying the glass melt gob was then immediately removed from beneath the pipe. Using an upper mold facing the lower mold and a sleeve mold, the glass melt was press molded into a thin disk shape measuring 66 mm in diameter and 2 mm in thickness. The press-molded article was cooled to a temperature at which it would not deform, removed from the mold, and annealed, yielding a substrate blank. In the molding, multiple lower molds were used and the outflowing glass melt was continuously molded into disk-shaped substrate blanks.

### (Method B)

The glass melt that had been clarified and homogenized was continuously cast from above into the through-holes of a heat-resistant casting mold provided with round through-holes, molded into round rods, and brought out from beneath the through holes. The glass that was brought out was annealed. The glass was then sliced at constant intervals in a direction perpendicular to the axis of the round rods using a multiwire saw to prepare disk-shaped substrate blanks.

Methods A and B above were employed in the present Examples. However, methods C and D, described below, are also suitable as methods for manufacturing disk-shaped substrate blanks.

### (Method C)

The above glass melt is caused to flow out onto a float bath, molded into sheet glass (molded by the floating method), and then annealed. Disk-shaped pieces of glass can be then cut from the sheet glass to obtain substrate blanks.

### (Method D)

The above glass melt is molded into sheet glass by the overflow down draw method (fusion method) and annealed. Disk-shaped pieces of glass can be then cut from the sheet glass to obtain substrate blanks.

(3) Preparation of Glass Substrates

Through-holes were formed in the center of substrate blanks obtained by the various above methods. The inner and outer circumferences thereof were ground and the main surfaces of the disks were lapped and polished (polished to mirror surfaces) to finish them into magnetic disk-use glass substrates 65 mm in diameter and 0.8 mm in thickness. The glass substrates obtained were cleaned with a 1.7 mass percent hydrofluosilicic acid (H₂SiF) aqueous solution and a 1 mass percent potassium hydroxide aqueous solution. They were then rinsed with pure water and dried. The surfaces of the substrates prepared from the glasses of Examples were observed under magnification, revealing no surface roughness. The surfaces were smooth.

Next, the disk-shaped glass substrates were immersed in a mixed salt melt of sodium nitrate and potassium nitrate and glass substrates having an ion-exchange layer on the surfaces thereof were obtained by ion exchange (chemical strengthening). The chemical strengthening conditions are given in Tables 2 to 5. Conducting the ion-exchange processing (chemical strengthening processing) in this manner effectively enhance the impact resistance of the glass substrates. The cross sections (cut surfaces of the ion-exchange layers) of glass substrates sampled from a number of glass substrates that had been subjected to the ion-exchange treatment were observed by the Babinet method and the fact that ion-exchange layers had formed was confirmed.

The ion-exchange layer can be formed over the entire region of the glass substrate surface, formed on just the outer circumference surface, or formed on just the outer circumference surface and the inner circumference surface.

After ion-exchange processing, it is possible to conduct mirror-surface polishing in a manner that does not remove the ion-exchange layer. In this process, a portion removed in polishing processing is desirably less than or equal to 10 μm, preferably less than or equal to 5 μm. By setting the portion removed as set forth above, the ion-exchange layer can be adequately remained not to excessively lower K_{1c}.

(4) Formation of Magnetic Disks

The following method was used to sequentially form an adhesive layer, undercoat layer, magnetic layer, protective layer, and lubricating layer on the main surface of each of the glass substrates prepared from the glass of Examples, yielding magnetic disks.

First, a film-forming apparatus in which a vacuum had been drawn was employed to sequentially form the adhesive layer, undercoat layer, and magnetic layer in an Ar atmosphere by the DC magnetron sputtering method.

At the time, the adhesive layer was formed as an amorphous CrTi layer 20 nm in thickness using a CrTi target. Next, a single-substrate, static opposed type film-forming apparatus was employed to form a layer 10 nm in thickness comprised of CrRu as an undercoat layer by the DC magnetron sputtering method in an Ar atmosphere. Further, the magnetic layer was formed at a film forming temperature of 400° C. using an FePt or CoPt target to obtain an FePt or CoPt layer 10 nm in thickness.

The magnetic disks on which magnetic layers had been formed were moved from the film-forming apparatus into a heating furnace and annealed under the condition suitably selected within a temperature range of 650 to 700° C.

Next, a 3 nm protective layer comprised of hydrogenated carbon was formed by CVD method using ethylene as the material gas. Subsequently, PFPE (perfluoropolyether) was used to form a lubricating layer by the dip coating method. The lubricating layer was 1 nm in thickness.

The above manufacturing process yielded magnetic disks.

1. Evaluation of the Glass

### (1) Glass Transition Temperature Tg and Thermal Expansion Coefficient

The glasses indicated in Tables 2 to 6 were processed into sheets and the glass transition temperatures Tg, average coefficient of linear expansion α at 100 to 300° C., and average coefficient of linear expansions at 500 to 600° C. of samples that had been chemically strengthened under the conditions described in Tables 2 to 6 were measured using a thermomechanical analyzer (Thermo plus TMA8310) made by Rigaku. None of the above characteristics underwent substantial change before and after the chemical strengthening processing. Thus, the glasses prior to chemical strengthening processing were also deemed to have the glass transition temperatures Tg, average coefficient of linear expansions α at 100 to 300° C., and average coefficient of linear expansions at 500 to 600° C. obtained by the above measurements.

The various characteristics of a sample of the glass indicated in Table 7 that had not been chemically strengthened were also measured in the above-described manner.

### (2) Young's Modulus

The Young's modulus of samples of the glasses indicated in Tables 2 to 6 that had been processed into sheets and subjected to a chemical strengthening treatment under the conditions given in Tables 2 to 6 was measured by an ultrasonic method. Since Young's modulus did not change substantially before and after chemical strengthening treatment, the glasses prior to chemical strengthening treatment were also deemed to have the Young's moduli obtained by the above measurement.

The Young's modulus of a sample of the glass indicated in Table 7 that had not been chemically strengthened was also measured in the above-described manner.

### (3) Specific Gravity

The specific gravity of samples of the glasses indicated in Tables 2 to 6 that had been processed into sheets and subjected to a chemical strengthening treatment under the conditions given in Tables 2 to 6 was measured by Archimedes' method. Since the specific gravity did not change substantially before and after chemical strengthening treatment, the glasses prior to chemical strengthening treatment were also deemed to have the specific gravity moduli obtained by the above measurement.

The specific gravity of a sample of the glass indicated in Table 7 that had not been chemically strengthened was also measured in the above-described manner.

### (4) Specific Modulus of Elasticity

The specific modulus of elasticity was calculated from the Young's modulus obtained in (2) above and the specific gravity obtained in (3).

### (5) Fracture Toughness

An MVK-E apparatus made by Akashi was employed. A Vickers indenter was pressed at a pressing load of 9.81 N into samples of the glasses indicated in Tables 2 to 6 that had been processed into sheets and chemically strengthened under the conditions given in Tables 2 to 5, introducing indentations and cracks into the samples.

A Vickers indenter was pressed at a pressing load of 4.9 N into samples of glasses Nos. 1 and 2 that had been subjected to chemical strengthening under the conditions described in Table 2, introducing indentations and cracks into the samples.

Loads of 9.81 or 4.9 N were applied in the same manner as set forth above to unstrengthened products of glasses Nos. 1 and 2 that had not been chemical strengthened, introducing indentations and cracks into the samples.

The Young's modulus E [GPa] of the sample, the diagonal length of the indentation, and the half-length of the surface cracks were measured, and the fracture toughness K_{1c} was calculated from the load and the Young's modulus of the sample.

### (6) Tav/Tmax

The glasses indicated in Tables 2 to 6 were processed into sheets and the cross-sections in the direction of plate thickness of samples that had been chemically strengthened under the conditions given in Tables 2 to 6 were observed by Babinet's method, Tmax and Tav were calculated by the above-described method, and Tav/Tmax was determined from the values that were calculated.

2. Evaluation of the Substrate (Surface Roughness, Surface Waviness)

A 5×5 μm square region of the main surface (the surface on which the magnetic recording layer and the like were deposited) of each substrate of the glasses indicated in Tables 2 to 6 before and after chemical strengthening was observed by an atomic force microscope (AFM) at a resolution of 256×256 pixels, and the arithmetic average Ra of the surface roughness as measured at a resolution of 512×256 pixels over an area of 1 μm×1 μm and the arithmetic average Ra of the surface roughness as measured over an area of 5×5 μm were measured.

The arithmetic average Wa of surface waviness at wavelengths of 100 μm to 950 μm of the main surface (surface on which the magnetic recording layer and the like were deposited) of each substrate before and after chemical strengthening was measured with an optical surface profilometer.

The arithmetic average Ra of the surface roughness measured for an area of 1 μm×1 μm ranged from 0.05 to 0.15 nm. The arithmetic average Ra of the surface roughness measured for an area of 5 μm×5 μm ranged from 0.03 to 0.12 nm. And the arithmetic average Wa of the surface waviness at wavelengths 100 μm to 950 μm was 0.2 to 0.5 nm. These ranges presented no problems for use as substrates in high recording density magnetic recording media.

TABLE 2

| | | No. 1 | | No. 2 | |
|---|---|---|---|---|---|
| | | mol % | mass % | mol % | mass % |
| Glass | SiO₂ | 61.00 | 59.00 | 60.00 | 58.06 |
| composition | Al₂O₃ | 11.00 | 18.00 | 11.00 | 18.07 |
| | Li₂O | 1.00 | 0.50 | 1.00 | 0.50 |
| | Na₂O | 10.50 | 10.50 | 11.00 | 11.00 |
| | K₂O | 0.0 | 0.0 | 0.0 | 0.0 |
| | MgO | 15.50 | 10.00 | 16.00 | 10.40 |
| | CaO | 0.0 | 0.0 | 0.0 | 0.0 |
| | SrO | 0.0 | 0.0 | 0.0 | 0.0 |
| | BaO | 0.0 | 0.0 | 0.0 | 0.0 |
| | ZrO | 1.00 | 2.00 | 1.00 | 2.00 |
| | Total | 100.0 | 100.0 | 100.0 | 100.0 |
| | MgO + CaO + SrO + BaO | 15.50 | 10.00 | 16.00 | 10.40 |
| | CaO/(MgO + CaO + SrO + BaO) | 0 | 0 | 0 | 0 |
| | MgO/(MgO + CaO + SrO + BaO) | 1 | 1 | 1 | 1 |
| | Li₂O/Na₂O | 0.095 | 0.048 | 0.091 | 0.045 |
| | Li₂O/(Li₂O + Na₂O + K₂O) | 0.087 | 0.045 | 0.083 | 0.043 |
| | Li₂O + Na₂O + K₂O | 11.50 | 11.00 | 12.00 | 11.50 |
| | MgO + CaO + SrO | 15.50 | 10.00 | 16.00 | 10.40 |
| | MgO + CaO | 15.50 | 10.00 | 16.00 | 10.40 |
| | (MgO + CaO)/(MgO + CaO + SrO + | 1.0 | 1.0 | 1.0 | 1.0 |
| | BaO) | | | | |
| | K₂O/(Li₂O + Na₂O + K₂O) | 0 | 0 | 0 | 0 |
| | Li₂O + Na₂O + K₂O + MgO + CaO + | 27.00 | 21.00 | 28.00 | 21.90 |
| | SrO | | | | |
| | (MgO + CaO + Li₂O)/(Li₂O + Na₂O + | 0.61 | 0.50 | 0.61 | 0.50 |
| | K₂O + MgO + CaO + SrO) | | | | |
| | (ZrO₂ + TiO₂ + Y₂O₃ + La₂O₃ + Gd₂O₃ + | 0.09 | 0.11 | 0.09 | 0.11 |
| | Nb₂O₅ + Ta₂O₅)/Al₂O₃ | | | | |
| | ZrO₂ + TiO₂ + Y₂O₃ + La₂O₃ + Gd₂O₃ + | 1.00 | 2.00 | 1.00 | 2.00 |
| | Nb₂O₅ + Ta₂O₅ | | | | |
| Characteristics | Specific gravity | 2.543 | | 2.545 | |
| | Glass transition temperature [° C.] | 680 | | 678 | |
| | Average thermal expansion coefficient | 74 | | 68 | |
| | [×10⁻⁷/° C.] (100 to 300° C.) | | | | |
| | Young's modulus[Gpa] | 83 | | 83 | |
| | Specific modulus of elasticity [MN/Kg] | 32.5 | | 32.6 | |
| | Tav/Tmax | 0.81 | | 0.84 | |
| Fracture tough- | Load 9.81 N(1000 gf) | 0.81 | | 0.8 | |
| ness value | Load 4.9 N(500 gf) | 0.81 | | 0.8 | |
| [Mpa · m^{1/2}] | | | | | |
| (Unstrengthened | | | | | |
| product) | | | | | |
| Chemical | Temperature [° C.] | 450 | | 450 | |
| strengthening | Period [h] | 4 | | 4 | |
| condition | Salt melt | | | | |

| | | | |
|---|---|---|---|
| | KNO₃ [%] | 60 | 60 |
| | NaNO₂ [%] | 40 | 40 |
| Fracture tough- | Load 9.81 N(1000 gf) | 1.8 | 1.78 |
| ness value | Load 4.9 N(500 gf) | 2.15 | 2.11 |
| [Mpa · m^{1/2}] | | | |
| (Strengthened | | | |
| product) | | | |

| | | |
|---|---|---|
| K₁ₒ (after)/K₁ₒ (before) | 2.22 | 2.23 |

TABLE 3

| | | No. 3 | | No. 4 | | No. 5 | | No. 6 | |
|---|---|---|---|---|---|---|---|---|---|
| | | mol % | mass % | mol % | mass % | mol % | mass % | mol % | mass % |
| Glass | SiO₂ | 65 | 64.70 | 65 | 63.55 | 67 | 67.00 | 66 | 64.42 |
| compo- | Al₂O₃ | 6 | 10.13 | 6 | 9.96 | 4 | 6.79 | 5 | 8.34 |
| sition | Li₂O | 1 | 0.50 | 1 | 0.49 | 1 | 0.50 | 1 | 0.49 |
| | Na₂O | 9 | 9.24 | 8 | 8.07 | 7 | 7.22 | 9 | 9.13 |
| | K₂O | 0 | 0.0 | 0 | 0.0 | 0 | 0.0 | 0 | 0.0 |
| | MgO | 17 | 11.35 | 14 | 9.18 | 17 | 11.40 | 16 | 10.56 |
| | CaO | 0 | 0.0 | 3 | 2.7 | 1 | 0.9 | 0 | 0.0 |
| | SrO | 0 | 0.0 | 0 | 0.0 | 0 | 0.0 | 0 | 0.0 |
| | BaO | 0 | 0.0 | 0 | 0.0 | 0 | 0.0 | 0 | 0.0 |
| | ZrO | 2 | 4.08 | 3 | 6.02 | 3 | 6.15 | 4 | 7.06 |
| | Total | 100 | 100 | 100 | 100 | 100 | 100 | 100 | 100 |
| | MgO + CaO + SrO + BaO | 17 | 11.35 | 17 | 11.92 | 18 | 12.33 | 16 | 10.56 |
| | CaO/(MgO + CaO + SrO + BaO) | 0.000 | 0.000 | 0.176 | 0.230 | 0.056 | 0.075 | 0.000 | 0.000 |
| | MgO/(MgO + CaO + SrO + BaO) | 1.000 | 1.000 | 0.824 | 0.770 | 0.944 | 0.925 | 1.000 | 1.000 |
| | Li₂O/Na₂O | 0.111 | 0.054 | 0.125 | 0.061 | 0.143 | 0.069 | 0.111 | 0.054 |
| | Li₂O/(Li₂O + Na₂O + K₂O) | 0.100 | 0.051 | 0.111 | 0.057 | 0.125 | 0.065 | 0.100 | 0.051 |
| | Li₂O + Na₂O + K₂O | 10.00 | 9.74 | 9.00 | 8.56 | 8.00 | 7.72 | 10.00 | 9.62 |
| | MgO + CaO + SrO | 17.00 | 11.35 | 17.00 | 11.92 | 18.00 | 12.33 | 16.00 | 10.56 |
| | MgO + CaO | 17.00 | 11.35 | 17.00 | 11.92 | 18.00 | 12.33 | 16.00 | 10.56 |
| | (MgO + CaO)/(MgO + CaO + | 1.0 | 1.0 | 1.0 | 1.0 | 1.0 | 1.0 | 1.0 | 1.0 |
| | SrO + BaO) | | | | | | | | |
| | K₂O/(Li₂O + Na₂O + K₂O) | 0 | 0 | 0 | 0 | 0 | 0 | 0 | 0 |
| | Li₂O + Na₂O + K₂O + MgO + | 27.00 | 21.09 | 26.00 | 20.48 | 26.00 | 20.05 | 26.00 | 20.18 |
| | CaO + SrO | | | | | | | | |
| | (MgO + CaO + Li₂O)/(Li₂O + | 0.67 | 0.58 | 0.89 | 0.51 | 0.73 | 0.64 | 0.85 | 0.55 |
| | Na₂O + K₂O + MgO + CaO + SrO) | | | | | | | | |
| | (ZrO₂ + TiO₂ + Y₂O₃ + La₂O₃ + | 0.33 | 0.40 | 0.50 | 0.60 | 0.75 | 0.91 | 0.70 | 0.85 |
| | Gd₂O₃ + Nb₂O₅ + Ta₂O₅)/Al₂O₃ | | | | | | | | |
| | ZrO₂ + TiO₂ + Y₂O₃ + La₂O₃ + | 2.00 | 4.08 | 3.00 | 6.02 | 3.00 | 6.15 | 3.50 | 7.08 |
| | Gd₂O₃ + Nb₂O₅ + Ta₂O₅ | | | | | | | | |

| Charac- | Specific gravity | | 2.543 | 2.545 | 2.57 | 2.58 |
|---|---|---|---|---|---|---|
| teristics | Glass transition temperature[° C.] | | 671 | 678 | 680 | 680 |
| | Average thermal expansion coefficient[×10⁻⁷/° C.] | | 66 | 68 | 61 | 66 |
| | (100 to 300° C.) | | | | | |
| | Average thermal expansion coefficient[×10⁻⁷/° C.] | | 77 | 77 | 71 | 77 |
| | (500 to 600° C.) | | | | | |
| | Young's modulus[Gpa] | | 84.0 | 83.0 | 86.2 | 85.3 |
| | Specific modulus of elasticity[MN/Kg] | | 33.0 | 32.6 | 33.5 | 33.0 |
| | Fracture | Strengthening temperature = 400° C. | 1.55 | 1.4 | 1.45 | 1.5 |
| | toughness | Strengthening period = 4 hours | | | | |
| | value | KNO₃:NaNO₃ = 60:40 | | | | |
| | [Mpa · m½] | Strengthening temperature = 450° C. | 1.75 | 1.5 | 1.6 | 1.65 |
| | | Strengthening period = 4 hours | | | | |
| | | KNO₃:NaNO₃ = 60:40 | | | | |
| | | Strengthening temperature = 500° C. | 1.8 | 1.55 | 1.65 | 1.7 |
| | | Strengthening period = 4 hours | | | | |
| | | KNO₃:NaNO₃ = 60:40 | | | | |
| | | Strengthening temperature = 550° C. | 2.1 | 1.8 | 1.7 | 1.75 |
| | | Strengthening period = 4 hours | | | | |
| | | KNO₃:NaNO₃ = 60:40 | | | | |
| | | Strengthening temperature = 600° C. | | | | |
| | | Strengthening period = 4 hours | | | | |
| | | KNO₃:NaNO₃ = 60:40 | | | | |

| | | | | |
|---|---|---|---|---|
| Tav/Tmax | 0.83 | 0.84 | 0.84 | 0.83 |
| Strengthening temperature = 400° C. | | | | |
| Strengthening period = 4 hours | | | | |
| KNO₃:NaNO₃ = 60:40 | | | | |

| | | No. 7 | | No. 8 | | No. 9 | |
|---|---|---|---|---|---|---|---|
| | | mol % | mass % | mol % | mass % | mol % | mass % |
| Glass | SiO₂ | 61 | 59.80 | 61 | 58.97 | 63 | 62.10 |
| compo- | Al₂O₃ | 11 | 18.30 | 11 | 18.05 | 10 | 16.73 |
| sition | Li₂O | 1 | 0.49 | 1 | 0.48 | 1 | 0.49 |
| | Na₂O | 7 | 6.57 | 11 | 10.47 | 6 | 6.10 |
| | K₂O | 0 | 0.0 | 0 | 0.0 | 0 | 0.0 |
| | MgO | 20 | 12.82 | 16 | 10.05 | 19 | 12.56 |
| | CaO | 0 | 0.0 | 0 | 0.0 | 0 | 0.0 |
| | SrO | 0 | 0.0 | 0 | 0.0 | 0 | 0.0 |
| | BaO | 0 | 0.0 | 0 | 0.0 | 0 | 0.0 |
| | ZrO | 1 | 2.01 | 1 | 1.98 | 1 | 2.02 |
| | Total | 100 | 100 | 100 | 100 | 100 | 100 |
| | MgO + CaO + SrO + BaO | 19.5 | 12.82 | 15.5 | 10.05 | 19 | 12.56 |
| | CaO/(MgO + CaO + SrO + BaO) | 0.000 | 0.000 | 0.000 | 0.000 | 0.000 | 0.000 |
| | MgO/(MgO + CaO + SrO + BaO) | 1.000 | 1.000 | 1.000 | 1.000 | 1.000 | 1.000 |
| | Li₂O/Na₂O | 0.154 | 0.075 | 0.095 | 0.048 | 0.167 | 0.080 |
| | Li₂O/(Li₂O + Na₂O + K₂O) | 0.133 | 0.069 | 0.087 | 0.044 | 0.143 | 0.074 |
| | Li₂O + Na₂O + K₂O | 7.50 | 7.08 | 11.50 | 10.95 | 7.00 | 6.58 |
| | MgO + CaO + SrO | 19.50 | 12.82 | 15.50 | 10.05 | 19.00 | 12.56 |
| | MgO + CaO | 19.50 | 12.82 | 15.50 | 10.05 | 19.00 | 12.56 |
| | (MgO + CaO)/(MgO + CaO + | 1.0 | 1.0 | 1.0 | 1.0 | 1.0 | 1.0 |
| | SrO + BaO) | | | | | | |
| | K₂O/(Li₂O + Na₂O + K₂O) | 0 | 0 | 0 | 0 | 0 | 0 |
| | Li₂O + Na₂O + K₂O + MgO + | 27.00 | 19.88 | 27.00 | 21.00 | 26.00 | 19.15 |
| | CaO + SrO | | | | | | |
| | (MgO + CaO + Li₂O)/(Li₂O + | 0.76 | 0.67 | 0.61 | 0.50 | 0.77 | 0.68 |
| | Na₂O + K₂O + MgO + CaO + SrO) | | | | | | |
| | (ZrO₂ + TiO₂ + Y₂O₃ + La₂O₃ + | 0.09 | 0.11 | 0.09 | 0.11 | 0.10 | 0.12 |
| | Gd₂O₃ + Nb₂O₅ + Ta₂O₅)/Al₂O₃ | | | | | | |
| | ZrO₂ + TiO₂ + Y₂O₃ + La₂O₃ + | 1.00 | 2.01 | 1.00 | 1.98 | 1.00 | 2.02 |
| | Gd₂O₃ + Nb₂O₅ + Ta₂O₅ | | | | | | |

| | | | | |
|---|---|---|---|---|
| Charac- | Specific gravity | 2.56 | 2.35 | 2.54 |
| teristics | Glass transition temperature[° C.] | 706 | 678 | 703 |
| | Average thermal expansion coefficient[×10⁻⁷/° C.] | 58 | 70 | 56 |
| | (100 to 300° C.) | | | |
| | Average thermal expansion coefficient[×10⁻⁷/° C.] | 68 | 82 | 85 |
| | (500 to 600° C.) | | | |
| | Young's modulus[Gpa] | 89.2 | 83.4 | 88.4 |
| | Specific modulus of elasticity[MN/Kg] | 36.0 | 33.9 | 35.7 |

| | | | | |
|---|---|---|---|---|
| Fracture | Strengthening temperature = 400° C. | 1.7 | 1.6 | 1.55 |
| toughness | Strengthening period = 4 hours | | | |
| value | KNO₃:NaNO₃ = 60:40 | | | |
| [Mpa · m½] | Strengthening temperature = 450° C. | 1.8 | 1.8 | 1.75 |
| | Strengthening period = 4 hours | | | |
| | KNO₃:NaNO₃ = 60:40 | | | |
| | Strengthening temperature = 500° C. | 2 | 2.1 | 2 |
| | Strengthening period = 4 hours | | | |
| | KNO₃:NaNO₃ = 60:40 | | | |
| | Strengthening temperature = 550° C. | 1.95 | 2.55 | 2.55 |
| | Strengthening period = 4 hours | | | |
| | KNO₃:NaNO₃ = 60:40 | | | |
| | Strengthening temperature = 600° C. | 1.95 | 2.6 | 2.5 |
| | Strengthening period = 4 hours | | | |
| | KNO₃:NaNO₃ = 60:40 | | | |

| | | | |
|---|---|---|---|
| Tav/Tmax | 0.85 | 0.81 | 0.8 |
| Strengthening temperature = 400° C. | | | |
| Strengthening period = 4 hours | | | |
| KNO₃:NaNO₃ = 60:40 | | | |

TABLE 4

| | | No. 10 | | No. 11 | |
|---|---|---|---|---|---|
| | | mol % | mass % | mol % | mass % |
| Glass | SiO₂ | 66.00 | 65.55 | 65.50 | 64.48 |
| composition | Al₂O₃ | 5.00 | 8.43 | 5.00 | 8.35 |
| | Li₂O | 1 | 0.49 | 1 | 0.49 |
| | Na₂O | 7 | 7.17 | 8 | 8.12 |
| | K₂O | 0.0 | 0.0 | 0.0 | 0.0 |
| | MgO | 17.0 | 11.33 | 16.0 | 10.57 |
| | CaO | 1.0 | 0.9 | 1.0 | 0.9 |
| | SrO | 0.0 | 0.0 | 0.0 | 0.0 |
| | BaO | 0.0 | 0.0 | 0.0 | 0.0 |
| | ZrO | 3.0 | 6.11 | 3.5 | 7.07 |
| | Total | 100.0 | 100.0 | 100.0 | 100.0 |
| | MgO + CaO + SrO + BaO | 18.00 | 12.26 | 17.00 | 11.49 |
| | CaO/(MgO + CaO + SrO + BaO) | 0.056 | 0.076 | 0.059 | 0.080 |
| | MgO/(MgO + CaO + SrO + BaO) | 0.944 | 0.924 | 0.941 | 0.920 |
| | Li₂O/Na₂O | 0.143 | 0.068 | 0.125 | 0.060 |
| | Li₂O/(Li₂O + Na₂O + K₂O) | 0.125 | 0.064 | 0.111 | 0.057 |
| | Li₂O + Na₂O + K₂O | 8.00 | 7.66 | 9.00 | 8.61 |
| | MgO + CaO + SrO | 18.00 | 12.26 | 17.00 | 11.49 |
| | MgO + CaO | 18.00 | 12.26 | 17.00 | 11.49 |
| | (MgO + CaO)/(MgO + CaO + SrO + | 1.00 | 1.00 | 1.00 | 1.00 |
| | BaO) | | | | |
| | K₂O/(Li₂O + Na₂O + K₂O) | 0.00 | 0.00 | 0.00 | 0.00 |
| | Li₂O + Na₂O + K₂O + MgO + CaO + | 26.00 | 19.92 | 26.00 | 20.10 |
| | SrO | | | | |
| | (MgO + CaO + Li₂O)/(Li₂O + Na₂O + | 0.731 | 0.640 | 0.692 | 0.596 |
| | K₂O + MgO + CaO + SrO) | | | | |
| | (ZrO₂ + TiO₂ + Y₂O₃ + La₂O₃ + Gd₂O₃ + | 0.600 | 0.725 | 0.700 | 0.847 |
| | Nb₂O₅ + Ta₂O₅)/Al₂O₃ | | | | |
| | ZrO₂ + TiO₂ + Y₂O₃ + La₂O₃ + Gd₂O₃ + | 3.00 | 6.11 | 3.50 | 7.07 |
| | Nb₂O₅ + Ta₂O₅ | | | | |

| | | | |
|---|---|---|---|
| Characteristics | Fracture toughness value[Mpa · m^{1/2}] | 1.68 | 1.39 |
| | Chemical strengthening temperature [° C.] | 500 | 450 |
| | Chemical strengthening period[hours] | 6 | 2 |
| | KNO₃:NaNO₃ | 90:10 | 80:20 |
| | Tav/Tmax | 0.85 | 0.84 |
| | Specific gravity | 2.58 | 2.59 |
| | Glass transition temperature[° C.] | 681 | 681 |
| | Average thermal expansion coefficient[×10⁻⁷/ | 63 | 65 |
| | ° C.] (100 to 300° C.) | | |
| | Average thermal expansion coefficient[×10⁻⁷/ | 73 | 76 |
| | ° C.] (500 to 600° C.) | | |
| | Young's modulus[Gpa] | 86.5 | 86.3 |
| | Specific modulus of elasticity[MN/Kg] | 33.5 | 33.3 |

TABLE 5

| | | No. 12 | | No. 13 | | No. 14 | |
|---|---|---|---|---|---|---|---|
| | | mol % | mass % | mol % | mass % | mol % | mass % |
| Glass | SiO₂ | 65 | 64.62 | 63 | 61.78 | 65.12 | 64.69 |
| compo- | Al₂O₃ | 6 | 10.12 | 10 | 16.64 | 6.01 | 10.13 |
| sition | Li₂O | 1 | 0.49 | 1 | 0.49 | 0.6 | 0.3 |
| | Na₂O | 9 | 9.23 | 6 | 6.07 | 9.24 | 9.46 |
| | K₂O | 0 | 0 | 0 | 0 | 0 | 0 |
| | MgO | 16.5 | 11.00 | 17.0 | 11.18 | 17.03 | 11.34 |
| | CaO | 0.5 | 0.46 | 2.0 | 1.83 | 0.0 | 0.00 |
| | SrO | 0 | 0.0 | 0 | 0.0 | 0 | 0.0 |
| | BaO | 0 | 0.0 | 0 | 0.0 | 0 | 0.0 |
| | ZrO | 2 | 4.08 | 1 | 2.01 | 2 | 4.08 |
| | Total | 100 | 100 | 100 | 100 | 100 | 100 |
| | MgO + CaO + SrO + BaO | 17.00 | 11.45 | 19.00 | 13.01 | 17.03 | 11.34 |
| | CaO/(MgO + CaO + SrO + BaO) | 0.029 | 0.040 | 0.105 | 0.141 | 0.000 | 0.000 |
| | MgO/(MgO + CaO + SrO + BaO) | 0.971 | 0.960 | 0.895 | 8.859 | 1.000 | 1.000 |
| | Li₂O/Na₂O | 0.111 | 0.053 | 0.167 | 0.081 | 0.065 | 0.032 |
| | Li₂O/(Li₂O + Na₂O + K₂O) | 0.100 | 0.050 | 0.143 | 0.075 | 0.061 | 0.031 |
| | Li₂O + Na₂O + K₂O | 10.00 | 9.72 | 7.00 | 6.56 | 9.84 | 9.76 |
| | MgO + CaO + SrO | 17.00 | 11.45 | 19.00 | 13.01 | 17.03 | 11.34 |
| | MgO + CaO | 17.00 | 11.45 | 19.00 | 13.01 | 17.03 | 11.34 |
| | (MgO + CaO)/(MgO + CaO + | 1.0 | 1.0 | 1.0 | 1.0 | 1.0 | 1.0 |
| | SrO + BaO) | | | | | | |
| | K₂O/(Li₂O + Na₂O + K₂O) | 0 | 0 | 0 | 0 | 0 | 0 |
| | Li₂O + Na₂O + K₂O + MgO + | 27.00 | 21.18 | 26.00 | 19.57 | 26.87 | 21.10 |
| | CaO + SrO | | | | | | |
| | (MgO + CaO + Li₂O)/(Li₂O + | 0.67 | 0.56 | 0.77 | 0.69 | 0.66 | 0.55 |
| | Na₂O + K₂O + MgO + CaO + SrO) | | | | | | |
| | (ZrO₂ + TiO₂ + Y₂O₃ + La₂O₃ + | 0.33 | 0.40 | 0.10 | 0.12 | 0.33 | 0.40 |
| | Gd₂O₃ + Nb₂O₅ + Ta₂O₅)/Al₂O₃ | | | | | | |
| | ZrO₂ + TiO₂ + Y₂O₃ + La₂O₃ + | 2.00 | 4.08 | 1.00 | 2.01 | 2.00 | 4.08 |
| | Gd₂O₃ + Nb₂O₅ + Ta₂O₅ | | | | | | |

| Charac- | Specific gravity | | 2.55 | 2.56 | 2.544 |
|---|---|---|---|---|---|
| teristics | Glass transition temperature[° C.] | | 669 | 700 | 679 |
| | Average thermal expansion coefficient[×10⁻⁷/° C.] | | 67 | 56 | 67 |
| | (100 to 300° C.) | | | | |
| | Average thermal expansion coefficient[×10⁻⁷/° C.] | | 78 | 65 | 77 |
| | (500 to 600° C.) | | | | |
| | Young's modulus[Gpa] | | 83.9 | 86.4 | 84.1 |
| | Specific modulus of elasticity[MN/Kg] | | 32.9 | 33.8 | 33.1 |
| | Fracture | Strengthening temperature = 400° C. | 1.5 | 1.45 | 1.33 |
| | toughness | Strengthening period = 4 hours | | | |
| | value | KNO₃:NaNO₃ = 60:40 | | | |
| | [Mpa · m^{1/2}] | Strengthening temperature = 450° C. | 1.65 | 1.55 | 1.6 |
| | | Strengthening period = 4 hours | | | |
| | | KNO₃:NaNO₂ = 60:40 | | | |
| | | Strengthening temperature = 500° C. | 1.7 | 1.6 | 1.74 |
| | | Strengthening period = 4 hours | | | |
| | | KNO₃:NaNO₂ = 60:40 | | | |

| | Tav/Tmax | 0.80 | | 0.81 | | 0.76 | |
|---|---|---|---|---|---|---|---|
| | Strengthening temperature = 400° C. | | | | | | |
| | Strengthening period = 4 hours | | | | | | |
| | KNO3:NaNO3 = 60:40 | | | | | | |
| | | No. 15 | | No. 16 | | No. 17 | |
| | | mol % | mass % | mol % | mass % | mol % | mass % |
| Glass | SiO₂ | 64.94 | 64.56 | 64.61 | 64.19 | 64.02 | 63.59 |
| compo- | Al₂O₃ | 5.99 | 10.12 | 5.95 | 10.06 | 5.91 | 9.96 |
| sition | Li₂O | 0.6 | 0.3 | 8.4 | 0.2 | 0.2 | 0.1 |
| | Na₂O | 8.39 | 8.61 | 8.55 | 8.76 | 8.67 | 8.88 |
| | K₂O | 0 | 0 | 0 | 0 | 0 | 0 |
| | MgO | 16.98 | 11.32 | 16.90 | 11.26 | 16.74 | 11.15 |
| | CaO | 1.1 | 1.02 | 1.59 | 1.48 | 2.49 | 2.31 |
| | SrO | 0 | 0.0 | 0 | 0.0 | 0 | 0.0 |
| | BaO | 0 | 0.0 | 0 | 0.0 | 0 | 0.0 |
| | ZrO | 2 | 4.07 | 1.99 | 4.05 | 1.97 | 4.01 |
| | Total | 100 | 100 | 100 | 100 | 100 | 100 |
| | MgO + CaO + SrO + BaO | 18.08 | 12.34 | 18.49 | 12.74 | 19.23 | 13.46 |
| | CaO/(MgO + CaO + SrO + BaO) | 0.061 | 0.083 | 0.086 | 0.116 | 0.129 | 0.172 |
| | MgO/(MgO + CaO + SrO + BaO) | 0.939 | 0.917 | 0.914 | 0.884 | 0.871 | 0.828 |
| | Li₂O/Na₂O | 0.072 | 0.035 | 0.047 | 0.023 | 0.023 | 0.011 |
| | Li₂O/(Li₂O + Na₂O + K₂O) | 0.067 | 0.034 | 0.045 | 0.022 | 0.023 | 0.011 |
| | Li₂O + Na₂O + K₂O | 8.99 | 8.91 | 8.95 | 8.96 | 8.87 | 8.98 |
| | MgO + CaO + SrO | 18.08 | 12.34 | 18.49 | 12.74 | 19.23 | 13.46 |
| | MgO + CaO | 18.08 | 12.34 | 18.49 | 12.74 | 19.23 | 13.46 |
| | (MgO + CaO)/(MgO + CaO + | 1.0 | 1.0 | 1.0 | 1.0 | 1.0 | 1.0 |
| | SrO + BaO) | | | | | | |
| | K₂O/(Li₂O + Na₂O + K₂O) | 0 | 0 | 0 | 0 | 0 | 0 |
| | Li₂O + Na₂O + K₂O + MgO + | 27.07 | 21.25 | 27.44 | 21.70 | 28.10 | 22.44 |
| | CaO + SrO | | | | | | |
| | (MgO + CaO + Li₂O)/(Li₂O + | 0.69 | 0.59 | 0.69 | 0.60 | 0.69 | 0.60 |
| | Na₂O + K₂O + MgO + CaO + SrO) | | | | | | |
| | (ZrO₂ + TiO₂ + Y₂O₃ + La₂O₃ + | 0.33 | 0.40 | 0.33 | 0.40 | 0.33 | 0.40 |
| | Gd₂O₃ + Nb₂O₅ + Ta₂O₅)/Al₂O₃ | | | | | | |
| | ZrO₂ + TiO₂ + Y₂O₃ + La₂O₃ + | 2.00 | 4.07 | 1.99 | 4.05 | 1.97 | 4.01 |
| | Gd₂O₃ + Nb₂O₅ + Ta₂O₅ | | | | | | |

| Charac- | Specific gravity | | 2.553 | 2.562 | 2.569 |
|---|---|---|---|---|---|
| teristics | Glass transition temperature[° C.] | | 679 | 681 | 681 |
| | Average thermal expansion coefficient[×10⁻⁷/° C.] | | 66 | 67 | 88 |
| | (100 to 300° C.) | | | | |
| | Average thermal expansion coefficient[×10⁻⁷/° C.] | | 76 | 78 | 79 |
| | (500 to 600° C.) | | | | |
| | Young's modulus[Gpa] | | 84.9 | 85.1 | 85.8 |
| | Specific modulus of elasticity[MN/Kg] | | 33.3 | 33.2 | 33.4 |
| | Fracture | Strengthening temperature = 400° C. | 1.24 | 1.1 | 1.1 |
| | toughness | Strengthening period = 4 hours | | | |
| | value | KNO₃:NaNO₃ = 60:40 | | | |
| | [Mpa · m^{1/2}] | Strengthening temperature = 450° C. | 1.35 | 1.28 | 1.28 |
| | | Strengthening period = 4 hours | | | |
| | | KNO₃:NaNO₂ = 60:40 | | | |
| | | Strengthening temperature = 500° C. | 1.58 | 1.41 | 1.41 |
| | | Strengthening period = 4 hours | | | |
| | | KNO₃:NaNO₂ = 60:40 | | | |

| | | | |
|---|---|---|---|
| Tav/Tmax | 0.77 | 0.65 | 0.51 |
| Strengthening temperature = 400° C. | | | |
| Strengthening period = 4 hours | | | |
| KNO3:NaNO3 = 60:40 | | | |

TABLE 6

| | | No. 18 | | No. 19 | | No. 20 | | No. 21 | | No. 22 | |
|---|---|---|---|---|---|---|---|---|---|---|---|
| | | mol % | mass % | mol % | mass % | mol % | mass % | mol % | mass % | mol % | mass % |
| Glass | SiO₂ | 64.60 | 64.00 | 64.74 | 64.20 | 65.70 | 65.15 | 65.37 | 64.92 | 65.26 | 64.79 |
| compo- | Al₂O₃ | 5.95 | 10.02 | 5.97 | 10.06 | 6.00 | 10.10 | 6.06 | 10.17 | 6.03 | 10.15 |
| sition | Li₂O | 0.20 | 0.10 | 0.40 | 0.20 | 0.10 | 0.05 | 0.10 | 0.05 | 0.10 | 0.05 |
| | Na₂O | 10.39 | 10.62 | 9.99 | 10.23 | 9.00 | 9.20 | 9.18 | 9.38 | 9.35 | 9.56 |
| | K₂O | 0.0 | 0.0 | 0.0 | 0.0 | 0.0 | 0.0 | 0.0 | 0.0 | 0.0 | 0.0 |
| | MgO | 16.88 | 11.22 | 16.91 | 11.26 | 17.20 | 11.43 | 17.24 | 11.39 | 17.21 | 11.37 |
| | CaO | 0.0 | 0.0 | 0.0 | 0.0 | 0.0 | 0.0 | 0.0 | 0.0 | 0.0 | 0.0 |
| | SrO | 0.0 | 0.0 | 0.0 | 0.0 | 0.0 | 0.0 | 0.0 | 0.0 | 0.0 | 0.0 |
| | BaO | 0.0 | 0.0 | 0.0 | 0.0 | 0.0 | 0.0 | 0.0 | 0.0 | 0.0 | 0.0 |
| | ZrO | 1.98 | 4.04 | 1.99 | 4.05 | 2.00 | 4.07 | 2.00 | 4.10 | 2.00 | 4.09 |
| | Total | 100 | 100 | 100 | 100 | 100 | 100 | 100 | 100 | 100 | 100 |
| | MgO + CaO + SrO + BaO | 16.88 | 11.22 | 16.91 | 11.25 | 17.20 | 11.43 | 17.24 | 11.39 | 17.21 | 11.37 |
| | CaO/(MgO + CaO + SrO + BaO) | 0.000 | 0.000 | 0.000 | 0.000 | 0.000 | 0.000 | 0.000 | 0.000 | 0.000 | 0.000 |
| | MgO/(MgO + CaO + SrO + BaO) | 1.000 | 1.000 | 1.000 | 1.000 | 1.000 | 1.000 | 1.000 | 1.000 | 1.000 | 1.000 |
| | Li₂O/Na₂O | 0.019 | 0.009 | 0.040 | 0.020 | 0.011 | 0.005 | 0.011 | 0.005 | 0.011 | 0.005 |
| | Li₂O/(Li₂O + Na₂O + K₂O) | 0.019 | 0.009 | 0.038 | 0.019 | 0.011 | 0.005 | 0.011 | 0.005 | 0.011 | 0.005 |
| | Li₂O + Na₂O + K₂O | 10.59 | 10.72 | 10.39 | 10.43 | 9.10 | 9.25 | 9.28 | 9.43 | 9.45 | 9.61 |
| | MgO + CaO + SrO | 16.88 | 11.22 | 16.91 | 11.26 | 17.20 | 11.43 | 17.24 | 11.39 | 17.21 | 11.37 |
| | MgO + CaO | 16.88 | 11.22 | 16.91 | 11.26 | 17.20 | 11.43 | 17.24 | 11.39 | 17.21 | 11.37 |
| | (MgO + CaO)/(MgO + CaO + | 1.0 | 1.0 | 1.0 | 1.0 | 1.0 | 1.0 | 1.0 | 1.0 | 1.0 | 1.0 |
| | SrO + BaO) | | | | | | | | | | |
| | K₂O/(Li₂O + Na₂O + K₂O) | 0 | 0 | 0 | 0 | 0 | 0 | 0 | 0 | 0 | 0 |
| | Li₂O + Na₂O + K₂O + MgO + | 27.47 | 21.94 | 27.30 | 21.69 | 26.30 | 20.68 | 26.52 | 20.82 | 26.66 | 20.98 |
| | CaO + SrO | | | | | | | | | | |
| | (MgO + CaO + Li₂O)/(Li₂O + | 0.62 | 0.52 | 0.53 | 0.53 | 0.66 | 0.56 | 0.65 | 0.55 | 0.65 | 0.54 |
| | Na₂O + K₂O + MgO + CaO + SrO) | | | | | | | | | | |
| | (ZrO₂ + TiO₂ + Y₂O₃ + La₂O₃ + | 0.33 | 0.40 | 0.33 | 0.40 | 0.33 | 0.40 | 0.33 | 0.40 | 0.33 | 0.40 |
| | Gd₂O₃ + Nb₂O₅ + Ta₂O₅)/Al₂O₃ | | | | | | | | | | |
| | ZrO₂ + TiO₂ + Y₂O₃ + La₂O₃ + | 1.98 | 4.04 | 1.99 | 4.05 | 2.00 | 4.07 | 2.00 | 4.10 | 2.00 | 4.09 |
| | Gd₂O₅ + Nb₂O₅ + Ta₂O₅ | | | | | | | | | | |

| Charac- | Specific gravity | | 2.543 | 2.545 | 2.542 | 2.544 | 2.543 |
|---|---|---|---|---|---|---|---|
| teristics | Glass transition temperature[° C.] | | 680 | 678 | 700 | 698 | 695 |
| | Average coefficient of linear expansion | | 74.3 | 68.0 | 64.7 | 70.6 | 63.5 |
| | [×10⁻⁷/° C.] (100 to 300° C.) | | | | | | |
| | Average coefficient of linear expansion | | 87.6 | 80.2 | 76.2 | 79.2 | 75.7 |
| | [×10⁻⁷/° C.] (500 to 600° C.) | | | | | | |
| | Young's modulus [Gpa] | | 83 | 83 | 83 | 83 | 83 |
| | Specific modulus of elasticity [MN/Kg] | | 32.6 | 32.6 | 32.7 | 32.6 | 32.6 |
| | Tav/Tmax | | 0.52 | 0.64 | 0.48 | 0.47 | 0.47 |
| Chemical | Temperature [° C.] | | 450 | 450 | 450 | 500 | 500 |
| strength- | Period[h] | | 4 | 4 | 4 | 4 | 4 |
| ening | Salt melt | KNO₃ [%] | 60 | 60 | 60 | 60 | 60 |
| condition | | NaNO₂ [%] | 40 | 40 | 40 | 40 | 40 |

TABLE 7

| | | No. 23 | |
|---|---|---|---|
| | | mol % | mass % |
| Glass | SiO₂ | 65 | 63.59 |
| composition | Al₂O₃ | 6 | 9.96 |
| | Li₂O | 1 | 0.10 |
| | Na₂O | 8 | 8.88 |
| | K₂O | 0 | 0 |
| | MgO | 12.0 | 11.15 |
| | CaO | 5.0 | 2.31 |
| | SrO | 0 | 0.0 |
| | BaO | 0 | 0.0 |
| | ZrO | 3 | 4.01 |
| | Total | 100 | 100 |
| | MgO + CaO + SrO + BaO | 17.00 | 13.46 |
| | CaO/(MgO + CaO + SrO + BaO) | 0.294 | 0.172 |
| | MgO/(MgO + CaO + SrO + BaO) | 0.706 | 0.828 |
| | Li₂O/Na₂O | 0.125 | 0.011 |
| | Li₂O/(Li₂O + Na₂O + K₂O) | 0.111 | 0.011 |
| | Li₂O + Na₂O + K₂O | 9.00 | 8.98 |
| | MgO + CaO + SrO | 17.00 | 13.46 |
| | MgO + CaO | 17.00 | 13.46 |
| | (MgO + CaO)/(MgO + CaO + SrO + | 1.0 | 1.0 |
| | BaO) | | |
| | K₂O/(Li₂O + Na₂O + K₂O) | 0 | 0 |
| | Li₂O + Na₂O + K₂O + MgO + CaO + | 26.00 | 22.44 |
| | SrO | | |
| | (MgO + CaO + Li₂O)/(Li₂O + Na₂O + | 0.69 | 0.60 |
| | K₂O + MgO + CaO + SrO) | | |
| | (ZrO₂ + TiO₂ + Y₂O₃ + La₂O₃ + | 0.50 | 0.40 |
| | Gd₂O₃ + Nb₂O₅ + Ta₂O₅)/Al₂O₃ | | |
| | ZrO₂ + TiO₂ + Y₂O₃ + La₂O₃ + | 3.00 | 4.01 |
| | Gd₂O₃ + Nb₂O₅ + Ta₂O₅ | | |

| | | |
|---|---|---|
| Character- | Specific gravity | 2.6 |
| istics | Glass transition temperature[° C.] | 670 |
| | Average thermal expansion | 67 |
| | coefficient[×10⁻⁷/° C.] (100 to 300° C.) | |
| | Average thermal expansion | 79 |
| | coefficient[×10⁻⁷/° C.] (500 to 600° C.) | |
| | Young's modulus[Gpa] | 85.8 |
| | Specific modulus of elasticity[MN/Kg] | 33.0 |

As shown in Tables 2 to 6, the glass substrates of Nos. 1 to 22 possessed all four of the characteristics required of magnetic recording media substrates, namely: high heat resistance (a high glass transition temperature), high stiffness (a high Young's modulus), a high thermal expansion coefficient, and high fracture toughness. Based on the results shown in Tables 2 to 6, the glass substrates of Nos. 1 to 22 were found to have high specific moduli of elasticity capable of withstanding high-speed rotation and low specific gravities, permitting substrate weight reduction. Additionally, the glasses used in Examples to fabricate glass substrates readily permitted the formation of ion-exchange layers by chemical strengthening processing. As a result, they were found to exhibit high fracture toughness.

From the above results, it was determined that an aspect of the present invention can provide the glass having characteristics that are required for magnetic recording medium substrates.

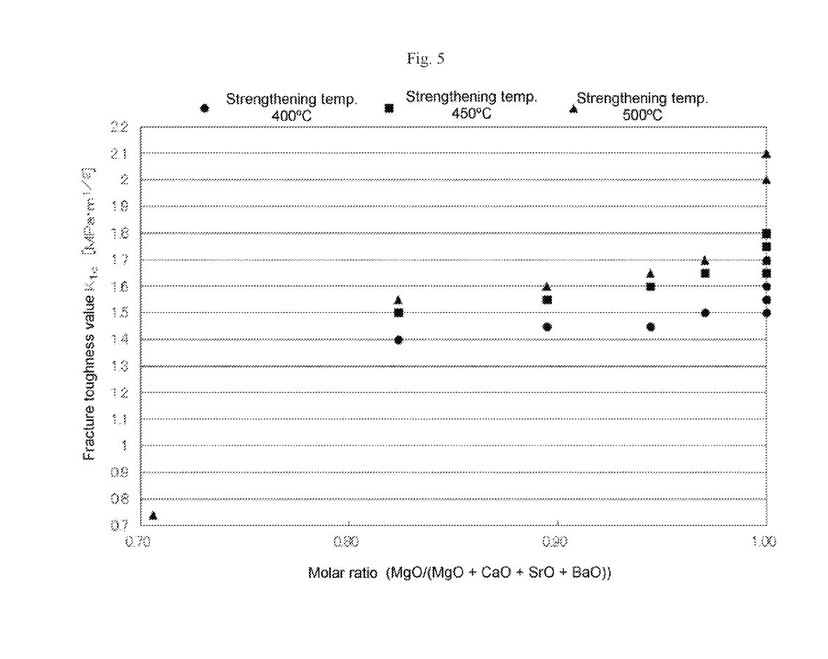

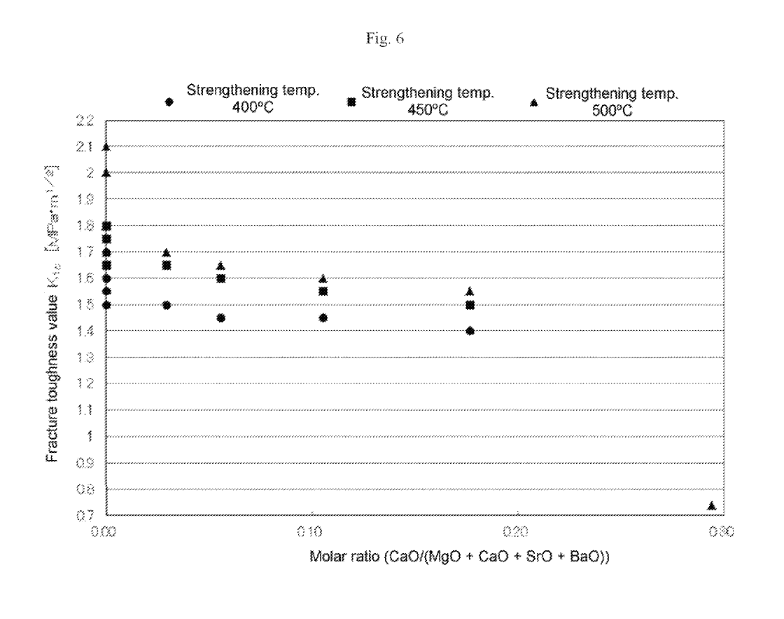

FIG. 5 is a graph in which the fracture toughness value following chemical strengthening is plotted against the molar ratio (MgO/(MgO+CaO+SrO+BaO)) for glasses Nos. 3 to 9, 10, and 11 in Tables 3 and 4. FIG. 6 is a graph in which the fracture toughness value following chemical strengthening is plotted against the molar ratio (CaO/(MgO+CaO+SrO+BaO)) for glasses Nos. 3 to 9, 10, and 11 in Tables 3 and 4.

From these graphs, it was determined that as the molar ratio (MgO/(MgO+CaO+SrO+BaO)) increased or the molar ratio (CaO/(MgO+CaO+SrO+BaO)) decreased, the fracture toughness value—that is, the mechanical strength—increased.

On the other hand, when chemical strengthening was conducted at a salt melt temperature of 500° C. using glass (No. 23) which had a molar ratio (MgO/(MgO+CaO+SrO+BaO)) of 0.706 and a molar ratio (CaO/(MgO+CaO+SrO+BaO)) of 0.294 as indicated in Table 7, the fracture toughness value was 0.74 MPa·m^{1/2}. Further, when multiple sheets of glass were simultaneously immersed in 500° C. salt melt and chemically strengthened, the salt melt deteriorated abruptly and the fracture toughness value after strengthening did not reach 0.74 MPa·m^{1/2}. Similarly, even when multiple pieces of glass were sequentially immersed in 500° C. salt melt and chemically strengthened, the fracture toughness value of the chemically strengthened glass dropped sharply from the second time on. This was presumed to have occurred because, as set forth above, the Ca²⁺ ions contained in the glass composition leached out into the salt melt, blocking the ion effect of the alkali metal ions. The same result was seen when the molar ratio (MgO/(MgO+CaO+SrO+BaO)) was smaller than 0.8 and the molar ratio (CaO/(MgO+CaO+SrO+BaO)) was smaller than 0.2.

By contrast, even when multiple pieces of the various glasses of Nos. 1 to 22 indicated in Tables 2 to 6 were chemically strengthened by being simultaneously immersed in salt melt, it was possible to maintain a fracture toughness value of greater than or equal to 0.90 MPa·m^{1/2}. Even when multiple pieces of the various glasses of Nos. 1 to 22 were sequentially immersed in salt melt and chemically strengthened, it was possible to maintain a fracture toughness value of greater than or equal to 0.90 MPa·m^{1/2}.

Thus, glasses with a molar ratio (MgO/(MgO+CaO+SrO+BaO)) of greater than or equal to 0.80 and a molar ratio (CaO/(MgO+CaO+SrO+BaO)) of less than or equal to 0.20 tended not to cause deterioration of the salt melt due to chemical strengthening, permitting the stable production of chemically strengthened glass having a high fracture toughness value. By contrast, at a molar ratio (MgO/(MgO+CaO+SrO+BaO)) of less than 0.80 and a molar ratio (CaO/(MgO+CaO+SrO+BaO)) exceeding 0.20, chemical strengthening caused deterioration of the salt melt and it was difficult to maintain a high fracture toughness value.

In glasses Nos. 1 to 9 following chemical strengthening, compressive stress layers 30 to 120 μm in depth were formed in the surface. The magnitude of the compressive stress was a value of greater than or equal to 2.0 kgf/mm² (a value of greater than or equal to 19.6 MPa). In glasses Nos. 10 to 18, compressive stress layers 20 to 120 μm in depth were formed in the surface. The magnitude of the compressive stress was a value of greater than or equal to 2.0 kgf/mm² (a value of greater than or equal to 19.6 MPa).

Based on these results, an aspect of the present invention was confirmed to provide glass having all of the characteristics required for a magnetic recording medium substrate.

Further, with the exception that mirror-surface polishing was conducted so as to remove a portion within a range suitably selected from 0.5 to 5 μm following ion-exchange processing, glass substrates were fabricated by the same method as above. Observation by the Babinet method of the cross sections of the multiple glass substrates obtained revealed the formation of ion-exchange layers and no deterioration of mechanical strength. Other characteristics were identical to those set forth above.

For the various Examples (the various glasses of Nos. 1 to 22 following chemical strengthening), in cross-sectional photographs obtained by observation by the Babinet method, the tensile stress distribution was convex in shape and there was no uphill in the stress profile in a virtual cross section perpendicular to the two main surfaces. When Tav/Tmax was calculated by the method set forth above that has been explained on the basis of FIG. 3 and based on these stress profiles, the Tav/Tmax value following chemical strengthening of glasses Nos. 1 to 15 was greater than or equal to 0.7. The Tav/Tmax values following chemical strengthening of glasses Nos. 16 to 22 was greater than or equal to 0.4.

The following tests were conducted to demonstrate that the above chemically strengthened glass substrates exhibiting the above stress profiles did not indicate delayed fractures.

Indentations made by pressing a Vickers indenter at an indentation load of 9.81 N were present in the samples following chemical strengthening processing for which the fracture toughness value had been measured in Examples. The samples with indentations were placed in an environment tester and left standing for 7 days in an environment of a temperature of 80° C. and a relative humidity of 80%. They were then removed and the indentations were observed. For each of Examples, 100 samples were prepared and the test was conducted. As a result, no crack extension was observed from the indentations in any of the samples.

Based on the above acceleration testing for delayed fracturing, a delayed fracturing prevention effect was found to have been achieved in the chemically strengthened glass substrates of Examples.

3. Evaluation of Magnetic Disks

### (1) Flatness

Generally, a degree of flatness of less than or equal to 5 μm permits highly reliable recording and reproduction. The degree of flatness (the distance (difference in height) in the vertical direction (direction perpendicular to the surface) of the highest portion and lowest portion of the disk surfaces) of the surfaces of the various magnetic disks formed using the glass substrates of Examples by the above-described methods was measured with a flatness measuring apparatus. All of the magnetic disks had degrees of flatness of less than or equal to 5 μm. From these results, it can be determined that the glass substrates of Examples did not undergo substantial deformation even when processed at high temperature during the formation of an FePt layer or CoPt layer.

(2) Load/Unload Test

The various magnetic disks formed using the glass substrates of Examples by the above methods were loaded into a 2.5-inch hard disk drive that rotated at a high speed of 10,000 rpm and subjected to a load/unload test (“LUL” hereinafter). The spindle of the spindle motor in the above hard disk drive was made of stainless steel. The durability of all of the magnetic disks exceeded 600,000 cycles. Further, although crash failures and thermal asperity failures will occur during LUL testing with deformation due to a difference in the coefficient of thermal expansion with the spindle material and deflection due to high-speed rotation, such failures did not occur during testing of any of the magnetic disks.

(3) Impact Resistance Testing

Glass substrates for magnetic disks (2.5 inches, sheet thickness 0.8 mm) were prepared. A Model-15D made by Lansmont was employed to conduct impact testing. In the impact testing, the magnetic disk glass substrate was assembled into a dedicated impact testing jig prepared with a spindle and clamp members similar to those of a HDD, an impact in the form of a half sine wave pulse of 1,500 G was applied perpendicularly for 1 msec to the main surface, and the damage to the magnetic disk glass substrate was observed.

As a result, no damage was observed in the glass substrates of Examples. On the other hand, damage was observed in the glass substrate of Comparative Example. Detailed analysis was conducted on a portion at which the damage occurred, revealing that the damage mainly occurred in an inner diameter portion.

Based on the above results, the present invention was confirmed to yield a glass substrate for a magnetic recording medium that afforded excellent impact resistance and permitted recording and reproduction with high reliability.

A glass disk prepared by the above method using the glass substrate of Examples was loaded into the hard disk drive of a recording mode in which magnetization reversal was assisted by irradiating the magnetic disk with a laser beam (heat-assisted recording method) and a magnetic recording medium of the heat-assisted recording type was prepared. The magnetic recording apparatus contained a heat-assisted magnetic recording head with a heat source (laser beam source) heating the main surface of a magnetic recording medium (magnetic disk), a recording element and a reproduction element, and a magnetic disk. The magnetic head of the magnetic recording apparatus was a DFH (dynamic flying height) head and the rotational speed of the magnetic disk was 10,000 rpm.

A separately prepared magnetic disk was loaded into a hard disk drive employing a recording mode assisted by microwaves (microwave-assisted recording mode) and a microwave-assisted recording mode information recording apparatus was prepared. Such information recording apparatuses, combining a high Ku magnetic material and energy-assisted recording, permitted high-density recording in the manner set forth above.

An aspect of the present invention can provide an optimal magnetic recording medium for high-density recording.

Finally, each of the aspects set forth above will be summarized.

An aspect provides glass for a magnetic recording medium substrate, which contains SiO₂, Li₂O, Na₂O, and MgO as essential components, alkali metal oxides selected from the group consisting of Li₂O, Na₂O, and K₂O of 6 to 15 mol % in total, alkaline earth metal oxides selected from the group consisting of MgO, CaO, SrO, and BaO of 10 to 30 mol % in total, wherein a molar ratio of a content of Li₂O to a total content of the alkali metal oxides {Li₂O/(Li₂O+Na₂O+K₂O)} is greater than 0 and less than or equal to 0.3, a molar ratio of a content of MgO to a total content of the alkaline earth metal oxides {MgO/(MgO+CaO+SrO+BaO)} is greater than or equal to 0.80 m, a glass transition temperature is greater than or equal to 650° C., and a Young's modulus is greater than or equal to 80 GPa.

The glass for a magnetic recording medium substrate preferably satisfies one or more of the characteristics and glass compositions set forth below.

The molar ratio of the total content of MgO, CaO, and Li₂O to the total content of the alkali metal oxides and alkaline earth metal oxides {(MgO+CaO+Li₂O)/(Li₂O+Na₂O+K₂O+MgO+CaO+SrO+BaO)} is greater than or equal to 0.50.

The molar ratio of the content of CaO to the total content of the alkaline earth metal oxides {CaO/(MgO+CaO+SrO+BaO)} is less than or equal to 0.20.

The glass has an average coefficient of linear expansion at 100 to 300° C. of greater than or equal to 55×10⁻⁷/° C.

Denoted as mol %, the SiO₂ content is 56 to 75%, the Al₂O₃ content is 1 to 20%, the Li₂O content is greater than 0% and less than or equal to 3%, the Na₂O content is greater than or equal to 1% and less than 15%, the MgO content is 8 to 30%, and the total content of oxides selected from the group consisting of ZrO₂, TiO₂, Y₂O₃, La₂O₃, Gd₂O₃, Nb₂O₅, and Ta₂O₅ is greater than 0 mol % and less than or equal to 10%.

Denoted as mol %, the SiO₂ content is 56 to 75%, the Al₂O₃ content is 1 to 20%, the Li₂O content is greater than 0% and less than or equal to 3%, the Na₂O content is greater than or equal to 1% and less than 15%, the K₂O content is greater than or equal to 0% and less than 3%, the MgO content is 8 to 30%, essentially no BaO is contained, and the molar ratio of the K₂O content to the total content of alkali metal oxides {K₂O/(Li₂O+Na₂O+K₂O)} is greater than or equal to 0.08.

The Li₂O content is less than or equal to 0.5 mol %, falling, for example, within a range of 0.08 to 0.5 mol %, and essentially no CaO is contained (that is, the CaO content is 0 mol %).

The specific modulus of elasticity is greater than or equal to 30 MNm/kg.

In one embodiment, the above glass for a magnetic recording medium substrate glass for chemical strengthening.

An aspect of the present invention provides a magnetic recording medium substrate comprised of the above glass for a magnetic recording medium substrate.

The above magnetic recording medium substrate is desirably a substrate that has been obtained by chemically strengthening the glass for a magnetic recording medium substrate according to an aspect of the present invention.

In the above magnetic recording medium, the fracture toughness value is desirably greater than or equal to 0.9 MPa·m^{1/2}.

In one embodiment, the above magnetic recording medium substrate is comprised of chemically strengthened glass in which a tensile stress distribution is convex in shape such that the convex shape does not contain indentations indenting to a compressive stress side in a stress profile in a virtual cross section perpendicular to two main surfaces as obtained by the Babinet method.

In one embodiment, the above magnetic recording medium substrate is comprised of chemically strengthened glass in which an average value Tav of a tensile stress obtained by the Babinet method and a maximum value Tmax of the tensile stress satisfy the following expression (1):

Tav/Tmax≧0.4.

In addition, in one embodiment, the above magnetic recording medium substrate is comprised of glass that has been chemically strengthened by immersion in a salt melt containing sodium salt and potassium salt.

In addition, in one embodiment, the above magnetic recording medium substrate is comprised of glass, containing greater than or equal to 0.1 mol % of Li₂O, that has been chemically strengthened by immersion in the above salt melt.

In addition, in one embodiment, the arithmetic average roughness (Ra) of the main surface as measured at a 512×256 pixel resolution for a 1 μm square of the above magnetic recording medium substrate using an atomic force microscope is less than or equal to 0.15 nm.

In addition, in one embodiment, the above magnetic recording medium substrate is a substrate for a magnetic recording medium that is employed in a magnetic recording device with a rotational speed of greater than or equal to 5,000 rpm.

In addition, in one embodiment, the above magnetic recording medium substrate is a substrate for a magnetic recording medium employed in a magnetic recording device on which a dynamic flying height (DFH) head is mounted.

In addition, in one embodiment, the above magnetic recording medium substrate is employed in a magnetic recording medium for energy-assisted magnetic recording.

Another aspect of the present invention relates to a magnetic recording medium substrate blank comprised of the above glass for a magnetic recording medium substrate.

In one embodiment, the above magnetic recording medium substrate blank is disk-shaped.

Another aspect of the present invention relates to a method of manufacturing a magnetic recording medium substrate including processing the above magnetic recording medium substrate blank.

In one embodiment, the above method of manufacturing a magnetic recording medium substrate includes the step of chemically strengthening by immersing the glass in a salt melt containing sodium salt and potassium salt.

In addition, in one embodiment, glass containing greater than or equal to 0.1 mol % of Li₂O is chemically strengthened by immersion in the salt melt.

In addition, in one embodiment, the above chemical strengthening is conducted so as to obtain chemically strengthened glass in which an average value Tav of a tensile stress obtained by the Babinet method and a maximum value Tmax of the tensile stress satisfy the following expression (1):

Tav/Tmax≧0.4 (1).

Tav/Tmax≧0.5 is preferred.

In addition, in one embodiment, the above chemical strengthening is conducted so as to obtain chemically strengthened glass in which a tensile stress distribution is convex in shape such that the convex shape does not contain indentations indenting to a compressive stress side in a stress profile in a virtual cross section perpendicular to two main surfaces as obtained by the Babinet method.

Another aspect of the present invention relates to a magnetic recording medium having a magnetic recording layer on the above magnetic recording medium substrate.

In one embodiment, the above magnetic recording layer contains a magnetic material comprising main components in the form of alloys of Pt with Co and/or Fe, and the magnetic recording medium is a magnetic recording medium for use in energy-assisted magnetic recording.

Another aspect of the present invention relates to a method of manufacturing a magnetic recording medium, including forming a film of magnetic material comprised primarily of alloys of Pt with Co and/or Fe on the main surface of the above magnetic recording medium substrate, and then conducting annealing to form a magnetic recording layer.

Another aspect of the present invention relates to an energy-assisted magnetic recording-type magnetic recording device including: a heat-assisted magnetic recording head having a heat source for heating at least the main surface of the magnetic recording medium, a recording element and a reproduction element; and the above magnetic recording medium.

In one embodiment, the rotational speed of the magnetic recording medium in the magnetic recording device is greater than or equal to 5,000 rpm.

In addition, in one embodiment, the magnetic recording device is a magnetic recording device on which a dynamic flying height (DFH) head is mounted.

All of the implementation modes disclosed herein are merely examples in all regards, and are not to be construed as limitations. The scope of the present invention is determined not by the above description, but by the claims. All equivalent meanings and all modifications within the scope are intended to be covered by the claims.

For example, as regards the glass compositions set forth by way of example above, by adjusting the composition described in the specification, it is possible to fabricate the glass for a magnetic recording medium substrate according to an aspect of the present invention.

It is also possible to combine any two or more items described as examples or desirable ranges in the specification.

1. Glass for a magnetic recording medium substrate, which comprises:
SiO₂, Li₂O, Na₂O, and MgO as essential components;
alkali metal oxides selected from the group consisting of Li₂O, Na₂O, and K₂O of 6 to 15 mol % in total;
alkaline earth metal oxides selected from the group consisting of MgO, CaO, SrO, and BaO of 10 to 30 mol % in total;
wherein a molar ratio of a content of Li₂O to a total content of the alkali metal oxides {Li₂O/(Li₂O+Na₂O+K₂O)} is greater than 0 and less than or equal to 0.3;
a molar ratio of a content of MgO to a total content of the alkaline earth metal oxides {MgO/(MgO+CaO+SrO+BaO)} is greater than or equal to 0.80;
a glass transition temperature is greater than or equal to 650° C.; and
a Young's modulus is greater than or equal to 80 GPa.

2. The glass for a magnetic recording medium substrate according to claim 1,
wherein a molar ratio of a total content of MgO, CaO, and Li₂O to a total content of the alkali metal oxides and alkaline earth metal oxides {(MgO+CaO+Li₂O)/(Li₂O+Na₂O+K₂O+MgO+CaO+SrO+BaO)} is greater than or equal to 0.50.

3. The glass for a magnetic recording medium substrate according to claim 1,
wherein a molar ratio of a content of CaO to a total content of the alkaline earth metal oxides {CaO/(MgO+CaO+SrO+BaO)} is less than or equal to 0.20.

4. The glass for a magnetic recording medium substrate according to claim 1, which has an average coefficient of linear expansion at 100 to 300° C. of greater than or equal to 55×10⁻⁷/° C.

5. The glass for a magnetic recording medium substrate according to claim 1, which comprises, denoted as mol %:
SiO₂ of 56 to 75%;
Al₂O₃ of 1 to 20%;
Li₂O of greater than 0% and less than or equal to 3%;
Na₂O of greater than or equal to 1% and less than 15%;
MgO of 8 to 30%; and
oxides selected from the group consisting of ZrO₂, TiO₂, Y₂O₃, La₂O₃, Gd₂O₃, Nb₂O₅, and Ta₂O₅ of greater than 0 mol % and less than or equal to 10% in total.

6. The glass for a magnetic recording medium substrate according to claim 1, which comprises, denoted as mol %:
SiO₂ of 56 to 75%;
Al₂O₃ of 1 to 20%;
Li₂O of greater than 0% and less than or equal to 3%;
Na₂O of greater than or equal to 1% and less than 15%;
K₂O of greater than or equal to 0% and less than 3%;
MgO of 8 to 30%, wherein essentially no BaO is contained,
a molar ratio of a content of K₂O to a total content of alkali metal oxides {K₂O/(Li₂O+Na₂O+K₂O)} is greater than or equal to 0.08.

7. The glass for a magnetic recording medium substrate according to claim 1, which has a specific modulus of elasticity of greater than or equal to 30 MNm/kg.

8. The glass for a magnetic recording medium substrate according to claim 1, which is glass for chemical strengthening.

9. A magnetic recording medium substrate, which is comprised of the glass for a magnetic recording medium substrate according to claim 1.

10. A magnetic recording medium substrate, which is a substrate that has been obtained by chemically strengthening the glass for a magnetic recording medium substrate according to claim 1.

11. The magnetic recording medium substrate according to claim 9, which is comprised of glass having a fracture toughness value of greater than or equal to 0.9 MPa·m^{1/2}.

12. The magnetic recording medium substrate according to claim 10, which is comprised of chemically strengthened glass in which a tensile stress distribution is convex in shape such that the convex shape does not contain indentations indenting to a compressive stress side in a stress profile in a virtual cross section perpendicular to two main surfaces as obtained by the Babinet method.

13. The magnetic recording medium substrate according to claim 10, which is comprised of chemically strengthened glass in which an average value Tav of a tensile stress obtained by the Babinet method and a maximum value Tmax of the tensile stress satisfy the following expression (1):
Tav/Tmax≧0.4 (1).
